(19) United States
(12) Patent Application Publication
(10) Pub. No.: US 2025/0383490 A1
(43) Pub. Date: Dec. 18, 2025

(54) NON-CONDUCTIVE PIGMENTS IN A MULTI-LAYER FILM AND METHODS OF MAKING

(71) Applicant: PPG Industries Ohio, Inc., Cleveland, OH (US)

(72) Inventors: Eldon L. Decker, Gibsonia, PA (US); Rachel Dory Harris, Pittsburgh, PA (US); Nicolas Benjamin Duarte, Allison Park, PA (US); Daniel Connor, Evans City, PA (US)

(73) Assignee: PPG Industries Ohio, Inc., Cleveland, OH (US)

(21) Appl. No.: 18/834,617

(22) PCT Filed: Jan. 31, 2023
(86) PCT No.: PCT/US2023/061636

§ 371 Date: Jul. 30, 2024

Related U.S. Application Data
(60) Provisional application No. 63/304,871, filed on Jan. 31, 2022.
(60) Provisional application No. 63/371,403, filed on Aug. 15, 2022.

(51) Int. Cl. G02B 5/20; C08K 9/02; C08K 9/08; C09C 1/00; C09D 7/40; C09D 7/62

(52) U.S. Cl. CPC G02B 5/208; C09C 1/0051; C09D 7/62; C09D 7/70; C01P 2004/20; C01P 2004/54; C01P 2006/40; C08K 9/02; C08K 9/08; C09C 2200/302; C09C 2200/303; C09C 2210/10

(57) ABSTRACT

Non-conductive pigments, coatings, films, articles, methods of manufacture thereof, and methods of use thereof are provided. The non-conductive pigment comprises a flake comprising at least four layers comprising alternating low index of refraction layers and high index of refraction layers. A difference in an average index of refraction between adjacent layers as measured over a wavelength range of 400 nm to 700 nm is at least 1.5. In certain examples, the high index of refraction layers have a Q value of at least 0.930, such as, at least 0.950 or at least 1.000. The pigment has an average visible specular reflectance of at least 80% and the pigment exhibits and the flake has a bandwidth of at least 300 nm between an upper wavelength and a lower wavelength at which a specular reflectance drops below 50%.

The present application is a 35 U.S.C. § 371 U.S. National Stage of PCT Application No. PCT/US2023/061636, filed on Jan. 31, 2023, which claims the benefit of and priority to U.S. Provisional Patent Application 63/304,871, filed Jan. 31, 2022 and U.S. Provisional Patent Application 63/371,403, filed Aug. 15, 2022. The entire content of each of the aforementioned patent applications is incorporated herein by reference.

### FIELD

The present disclosure relates to non-conductive pigments, coatings, films, methods of manufacture thereof, and methods of use thereof.

### BACKGROUND

The use of radar is becoming ubiquitous in modern transportation including passenger vehicles with advanced driver assistance systems (ADAS), such as adaptive cruise control (ACC), automatic braking, and the like. The use of radar will likely increase as further advances in autonomous driving are implemented. However, radar performance can be hindered by unwanted radar signal loss that may result from the use of metallic pigments, such as aluminum flakes, commonly used in coatings to achieve a certain luster, sparkle, and/or a metallic color. Accordingly, coatings, films, and articles of manufacture that minimize interference with radar while providing the desired appearance are desired.

### SUMMARY

The present disclosure relates in at least one example to a non-conductive pigment. The non-conductive pigment can include at least four layers comprising alternating low index of refraction layers and high index of refraction layers. In this example, a difference in an average index of refraction between adjacent layers as measured over a wavelength range of 400 nm to 700 nm is at least 1.5, at least 2, at least 2.4, at least 2.5, at least 2.7, at least 3, or at least 4. The high index of refraction layers have a Q value of at least 0.930, such as, at least 0.950 or at least 1.000. In this example, Q=(3/2)×(nₐᵥₑ−(kₐᵥₑ/2))/(nₐᵥₑ+2), kₐᵥₑ is the average extinction coefficient of the respective layer as measured over a wavelength range of 400 nm to 700 nm, and nₐᵥₑ is the average index of refraction of the respective layer as measured over a wavelength range of 400 nm to 700 nm. In addition, the non-conductive pigment can have an average visible specular reflectance of at least 80%, such as, at least 85%, at least 90%, or at least 95% and the pigment exhibits at least 50% of a maximum of the visible specular reflectance across a wavelength bandwidth of at least 300 nm between an upper wavelength and a lower wavelength at which a specular reflectance drops below 50%. Furthermore, the average visible specular reflectance can be measured using an integrating sphere spectrophotometer averaging the reflectance values over a wavelength range of 400 to 700 nm for both a specular component included (SCI) mode and a specular component excluded (SCE) mode, and then subtracting an average reflectance in the SCE mode from an average reflectance in the SCI mode.

In addition, the non-conductive pigment can have a near infrared specular reflectance less than 40%, such as less than 30%, or such less than 20%, such as 2% and has a near infrared specular transmittance of at least 60%, such as at least 70%, such as 80%, or such as 90%, at a wavelength between 700 to 3000 nm, where the transmittance at each wavelength conforms to the equation percent transmittance≤100−percent reflectance. Furthermore, the infrared specular reflectance can be measured using an integrating sphere spectrophotometer at wavelength values between 700 to 3000 nm for both a specular component included (SCI) mode and a specular component excluded (SCE) mode, and then subtracting the reflectance in the SCE mode at a given wavelength from the reflectance in the SCI mode at the same wavelength. Furthermore, the infrared specular transmittance can be measured using an integrating sphere spectrophotometer at wavelength values between 700 to 3000 nm for both a specular component included (SCI) mode and a specular component excluded (SCE) mode, and then subtracting the transmittance in the SCE mode at a given wavelength from the transmittance in the SCI mode at the same wavelength. Such near infrared wavelengths relevant to lidar detection would include 905 nm and 1550 nm.

In addition, a method of making a pigment can include individually depositing alternating high index of refraction layers and low index of refraction layers over a substrate to form a composite on the substrate. The method can also include removing the composite from the substrate; and processing the composite to form flakes. In this exemplary method, the alternating high index of refraction layers and low index of refraction layers can include at least four layers having alternating low index of refraction layers and high index of refraction layers. In one example, the difference in an average index of refraction between adjacent layers, as measured over a wavelength range of 400 nm to 700 nm, is at least 1.5, and the high index of refraction layers have a Q value of at least 0.930. In this case, Q=(3/2)×(nₐᵥₑ−(kₐᵥₑ/2))/(nₐᵥₑ+2), where kₐᵥₑ is an average extinction coefficient of the high index of refraction layers over a wavelength range of 400 nm to 700 nm, and nₐᵥₑ is an average index of refraction of the high index of refraction layers over the wavelength range of 400 nm to 700 nm. Furthermore, the non-conductive pigment can have an average visible specular reflectance of at least 80%, and the flake can have a bandwidth of at least 300 nm between an upper wavelength and a lower wavelength at which a specular reflectance drops below 50%.

Furthermore, an additional or alternative method can include improving radio detection and ranging in an electromagnetic radiation frequency range of 76 GHz to 81 GHz with automotive radar sensors that are mounted behind metallic effect-coated article. This method can include in at least one example applying a coating composition having the non-conductive pigment of noted above to an automotive substrate, and curing the applied coating composition to form a coated automotive substrate having the non-conductive pigment.

Still further, an additional or alternative method can include making a non-conductive pigment by depositing four or more alternating layers of a high index of refraction layer and a low index of refraction layer over a substrate to form a composite. In this case, the high index of refraction layers can include silicon, and the high index of refraction layers can have a Q value of at least 0.890. In addition, Q=(3/2)×(nₐᵥₑ−(kₐᵥₑ/2))/(nₐᵥₑ+2), where kₐᵥₑ is an average extinction coefficient of the high index of refraction layers over a wavelength range of 400 nm to 700 nm, and nₐᵥₑ is an average index of refraction of the high index of refraction layers over the wavelength range of 400 nm to 700 nm. The method can further include removing the composite from the substrate, and processing the composite to form the non-conductive pigment.

It is understood that this disclosure is not limited to the examples summarized in this Summary. Various other aspects are described and exemplified herein.

### BRIEF DESCRIPTION OF THE DRAWINGS

The features and advantages of the examples, and the manner of attaining them, will become more apparent, and the examples will be better understood, by reference to the following description taken in conjunction with the accompanying drawings, wherein:

FIG. 1 1 is a schematic view of a non-conductive pigment comprising at least two layers;

FIG. 2 is a schematic view of a non-conductive pigment comprising at least four layers; and

FIG. 3 is a schematic view of a non-conductive pigment comprising n total layers;

FIG. 4 is a flowchart showing a series of acts in a method of forming flakes;

FIG. 5 is a flowchart showing a series of acts in a method of applying a coating with non-conductive pigment;

FIG. 6 is a flowchart showing a series of acts in a method of forming a non-conductive pigment;

FIG. 7 is a flowchart showing a series of acts in a method of forming a pigment of a particular thickness; and

FIG. 8 is a flowchart showing a series of acts in an additional method of forming a pigment of a particular thickness.

The exemplifications set out herein illustrate certain non-limiting embodiments, in one form, and such exemplifications are not to be construed as limiting the scope of the appended claims in any manner.

### DETAILED DESCRIPTION

Metallic pigments, such as aluminum flakes, are commonly used in coatings as effect pigments to achieve a desirable luster, sparkle, and/or a metallic color. However, the use of metallic pigments in a coating can lead to a loss in radar transmission through the coating. Additionally, removal of the metallic pigment can increase radar transmission through the coating at the expense of the desirable luster, sparkle, and/or metallic color. Therefore, the present disclosure provides a non-conductive pigment that can achieve a desirable luster, sparkle, and/or metallic color with minimal (e.g., no greater than 0.5 dB, such as, for example, no greater than 0.3 dB or no greater than 0.1 dB), if any, radar transmission loss through a coating comprising the pigment. For example, the non-conductive pigment according to the present disclosure may have a substantially similar opacity to aluminum flakes. The non-conductive pigment may comprise at least four layers comprising alternating low index of refraction layers and high index of refraction layers. A difference in an average index of refraction between adjacent layers as measured over a wavelength range of 400 nm to 700 nm can be at least 1.5. The high index of refraction layers can have a Q value of at least 0.930. The non-conductive pigment may have an average visible specular reflectance of at least 80% and the pigment may exhibit at least 50% of a maximum of the visible specular reflectance across a wavelength bandwidth of at least 300 nm. The wavelength bandwidth can be calculated by starting at a first wavelength where the maximum peak reflectance value is measured in the reflectance spectrum and finding the shorter wavelength (λ₁) relative to the first wavelength where the reflectance value has dropped to half (50%) of the maximum peak reflectance value. Then, finding the longer wavelength (λ₂) relative to the first wavelength where the reflectance has dropped to half (50%) of the maximum peak reflectance value. The shorter wavelength is subtracted from the longer wavelength to find the wavelength bandwidth (e.g., wavelength bandwidth=Δλ=λ₂−λ₁).

As used herein, “adjacent” when used with respect to layers, means the layers are physically in contact with one another over at least a portion of each layer.

As used herein, “pigment” refers to an insoluble particle that provides reflective characteristics in the visible wavelengths of the electromagnetic spectrum. As used herein, the term “visible” refers to the visible wavelengths of the electromagnetic spectrum. For example, the visible wavelengths may be in a range of 400 nm to 700 nm. The pigments according to the present disclosure can provide visible light reflective characteristics to a composition that incorporates the pigment. As used herein, “insoluble” in reference to a pigment of the present disclosure means the pigment (including the components that comprise the pigment) is insoluble in water and the typical solvents, such as organic solvents, used in coating compositions, film compositions, and article of manufacture compositions. Solubility may be tested, for example, by making a 1 weight percent (wt %) mixture of the solute (e.g., pigment particle) in the desired medium based on the total weight of mixture, such as water and/or organic solvent(s), at ambient temperature and observing if the pigment dissolves into the desired medium it is soluble or otherwise if it remains as a separate phase it is insoluble. As used herein, “ambient temperature” refers to a temperature of 23° C.+/−3° C. Thus, when formulating a coating, a film, or an article incorporating the pigment according to the present disclosure, solvent(s) in which the pigment is insoluble may be chosen.

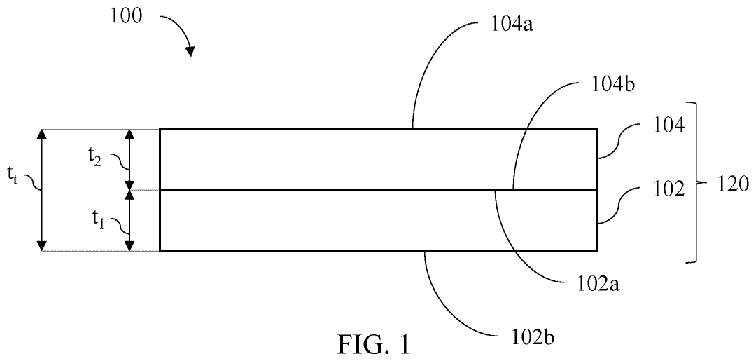

FIG. 1 is a schematic view of a non-conductive pigment 100 comprising at least two layers. The at least two layers of the non-conductive pigment 100 include a first layer 102 and a second layer 104 that is adjacent to the first layer 102. For example, at least a portion or all of a surface 102a of the first layer 102 can be at least in direct physical contact with at least a portion or all of a surface 104a of the second layer 104.

The first layer 102 has a first average index of refraction and the second layer 104 has a second average index of refraction. The first average index of refraction can be different from the second average index of refraction, such as, for example, at least 1.5, at least 2, at least 2.4, at least 2.5, at least 2.7, at least 3, or at least 4 different from the second average index of refraction.

One of the first layer 102 and the second layer 104 can be a “high” index of refraction layer and the other layer can be a “low” index of refraction layer. As used herein “high” and “low” when referring to the index of refraction of a layer refers to the average index of refraction of the layer relative to an adjacent layer. For example, the first layer 102 can be the high index of refraction layer and the second layer 104 can be the low index of refraction layer, or the first layer 102 can be the low index of refraction layer and the second layer 104 can be the high index of refraction layer. Without being bound to any particular theory, achieving a difference in the index of refraction between adjacent layers can enable Fresnel reflection of electromagnetic radiation in a wavelength in a range of 400 nm to 700 nm thereby enabling a desirable visible reflectance in the wavelength range of 400 nm to 700 nm. As used herein, a “period of layers” refers to two adjacent layers where one of the adjacent layers has a high index of refraction layer and the other of the adjacent layers has a low index of refraction layer. For example, the first layer 102 and the second layer 104 can be a period of layers 120.

The high index of refraction layer can have an average index of refraction greater than an average refractive index of the low index of refraction layer. For example, the average index of refraction of the high index of refraction layer can be at least 1.5, at least 2, at least 2.4, at least 2.5, at least 2.7, at least 3, or at least 4 greater than the average index of refraction of the low index of refraction layer. The average index of refraction of the high index of refraction layer can be at least 2.5, such as, for example, at least 3, at least 3.5, at least 4, or at least 4.5. The average index of refraction of the low index of refraction layer can be no greater than 2.5, such as no greater than 2.0, no greater than 1.9, no greater than 1.8, no greater than 1.7, no greater than 1.6, no greater than 1.5, or no greater than 1.4. As used herein, the “average index of refraction” refers to the real part of a complex-valued refractive index calculated by measuring a real part of a complex-valued index of refraction for a layer over a wavelength range of 400 nm to 700 nm in 1 nm increments and averaging the measured values.

Each of the high index of refraction layer and the low index of refraction layer can also comprise an associated extinction coefficient (e.g., the first layer 102 can comprise a first extinction coefficient and the second layer 104 can comprise a second extinction coefficient). The extinction coefficient of each of the high index of refraction layer and the low index of refraction layer can be below a desired level such that attenuation of electromagnetic radiation in the respective layer can be minimized. An extinction coefficient of the high index of refraction layer and/or the low index of refraction layer can be no greater than 2.0 such as, for example, no greater than 1.7, no greater than 1.0, no greater than 0.6, no greater than 0.5, no greater than 0.4, no greater than 0.3, no greater than 0.2, no greater than 0.1, no greater than 0.09, no greater than 0.08, no greater than 0.07, no greater than 0.06, no greater than 0.05, no greater than 0.04, no greater than 0.03, no greater than 0.02, or no greater than 0.01. As used herein, the “average extinction coefficient” refers to the imaginary part of a complex-valued refractive index calculated by measuring an imaginary part of a complex-valued index of refraction for a layer over a wavelength range of 400 nm to 700 nm in 1 nm increments and averaging the measured values.

A higher average index of refraction for the high index of refraction layer can lead to a higher average visible specular reflectance of the pigment. A higher average extinction coefficient can lead to an increased absorptance by the respective layer and therefore reduce the visible specular reflectance of the pigment. To balance the average index of refraction with the average extinction coefficient to achieve a desirable average visible reflectance of the pigment, the high index of refraction layer can comprise a Q value of at least 0.930, such as, for example, at least 0.950 or at least 1.000. Where

$$Q = ( 3 / 2 ) \times ( {n}_{ave} - ( {k}_{ave} / 2 ) ) / ( {n}_{ave} + 2 ) ,$$

where kₐᵥₑ is the average extinction coefficient of the respective layer as measured over a wavelength range of 400 nm to 700 nm; and
nₐᵥₑ is the average index of refraction of the respective layer as measured over a wavelength range of 400 nm to 700 nm;

The first layer 102 and/or the second layer 104, individually, can comprise a radar transmissive material, such as, for example, a semiconductor, a dielectric, or a combination thereof. “Radar transmissive” means suitable to transmit electromagnetic radiation at various radar frequencies (e.g., in the range of automotive frequencies of 76 GHz to 81 GHz) with minimal, if any, transmission loss. For example, the first layer 102 and/or the second layer 104, individually, can comprise silicon, silicon oxide (e.g., silicon dioxide), silicon nitride, zinc telluride, zinc oxide, gallium arsenide, gallium phosphide, iron sulfide, germanium, indium phosphide, indium tin oxide, magnesium fluoride, tantalum oxide, zirconium dioxide, titanium dioxide, a polymer, other semiconductors, other dielectrics, or a combination thereof. The first layer 102 and/or the second layer 104, individually, can comprise at least two materials and the index of refraction of the respective layer can be an average index of refraction of the at least two materials. The high index of refraction layer can comprise crystalline silicon, poly-crystalline silicon, amorphous silicon, gallium arsenide, gallium phosphide, iron sulfide, germanium, indium phosphide, or a combination thereof. The low index of refraction layer can comprise a polymer, silicon oxide, silicon nitride, indium tin oxide, magnesium fluoride, tantalum oxide, zirconium oxide, a polymer, or a combination thereof. The low index of refraction layer can comprise silicon oxide.

The polymer can comprise poly(hexafluoropropylene oxide), poly(tetrafluoroethylene-co-hexafluoropropylene), poly(pentadecafluorooctyl acrylate), acrylate), poly(tetrafluoro-3-poly(tetrafluoro-3-(heptafluoropropoxy)propyl (pentafluoroethoxy)propyl acrylate), poly(tetrafluoroethylene), poly(pentafluorovinyl propionate), poly(heptafluorobutyl acrylate), poly(trifluorovinyl acetate), poly(octafluoropentyl acrylate), poly(methyl hydro siloxane), poly(dimethyl siloxane), poly(trifluoroethyl acrylate), poly(trifluoroisopropyl methacrylate), poly(vinylidene fluoride), poly(trifluorocthyl methacrylate), poly(isobutyl methacrylate), poly(vinyl isobutyl ether), poly(ethylene oxide), poly(vinyl ethyl ether), poly(vinyl n-butyl ether), poly(propylene oxide), poly(vinyl n-octyl acrylate), poly(vinyl 2-ethylhexyl ether), poly(vinyl n-decyl ether), poly(2-methoxyethyl acrylate), poly(vinyl acetate), poly(vinyl propionate), poly(vinyl methyl ether), poly(ethyl acrylate), poly(isopropyl acrylate), Cellulose acetate butyrate, cellulose acetate, poly(vinyl formate), poly((meth) acrylate) (e.g., poly((methyl acrylate)), poly(n-propyl methacrylate), poly(ethyl methacrylate), poly(vinyl butyral), olefin polymers (such as polyethylene, polypropylene and their copolymers and blends with elastomers), poly(vinyl alcohol), poly(vinyl methacrylate), poly(acrylic acid), poly(caprolactam), poly(vinyl chloride), polystyrene, polyurethane, polycarbonate, poly(vinylidene chloride), poly(2-hydroxyethyl methacrylate), poly(p-xylylene), poly(glycidyl methacrylate), poly(allylamine), poly(amino styrene), poly(2-hydroxyethyl methacrylate), poly(methacrylic acid), poly(perfluorodecylacrylate), poly(2-hydroxyethyl methacrylate), poly(allylamine), poly(p-xylylene), a copolymer thereof, or a combination thereof. For example, the polymer can comprise a fluoropolymer, a polystyrene, an acrylic polymer, a methacrylic polymer, a copolymer thereof, or a combination thereof.

The first layer 102 can comprise a thickness, t₁, and the second layer 104 can comprise a thickness, t₂. Each thickness, t₁ and t₂, individually, can be in a range of 10 nm to 300 nm as measured with a transmission electron microscope (“TEM”), such as, for example, 30 nm to 200 nm, 50 nm to 100 nm, 10 nm to 150 nm, 10 nm to 100 nm, 15 nm to 75 nm, 15 nm to 50 nm, 15 nm to 35 nm, 20 nm to 35 nm, 40 nm to 120 nm, 50 nm to 100 nm, 60 nm to 90 nm, or 70 nm to 90 nm, all as measured with a TEM. A thickness of the low index of refraction layer can be in a range of 10 nm to 300 nm, such as, for example, 30 nm to 300 nm, such as, 30 nm to 200 nm, 50 nm to 100 nm, 60 nm to 90 nm, or 70 nm to 90 nm, all as measured with a TEM. A thickness of the high index of refraction layer can be in a range of 10 nm to 150 nm, such as, for example, 10 nm to 100 nm, 15 nm to 75 nm, 15 nm to 50 nm, 15 nm to 35 nm, or 20 nm to 35 nm.

The non-conductive pigment 100 can comprise at least three layers, and can be, for example, at least four layers, at least five layers, at least six layers, at least seven layers, or at least eight layers. Regardless of the quantity of layers, in any period of layers, one is a high index of refraction layer and one is a low index of refraction layer. Without being bound to any particular theory, achieving a non-conductive pigment comprising alternating high index of refraction layers and low index of refraction layers can enable Fresnel reflection of electromagnetic radiation in a wavelength in a range of 400 nm to 700 nm thereby enabling a desirable visible reflectance in the wavelength range of 400 nm to 700 nm.

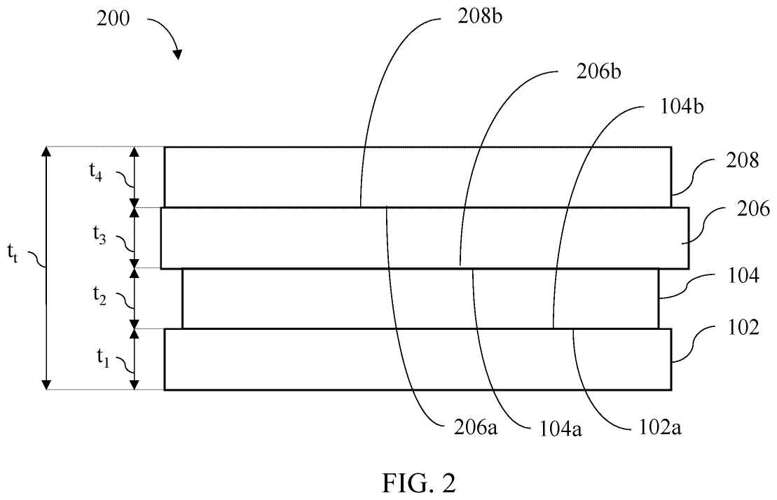

FIG. 2 is a schematic view of a non-conductive pigment 200 comprising at least four layers, including the first layer 102, the second layer 104, such as illustrated in FIG. 1, a third layer 206 that is adjacent to the second layer 104, and a fourth layer 208 that is adjacent to the third layer 206. For example, at least a portion or all of a surface 104a of the second layer 104 can be at least in direct physical contact with at least a portion or all of a surface 206b of the third layer 206 and at least a portion or all of a surface 206a of the third layer 206 can be at least in direct physical contact with at least a portion or all of a surface 208b of the fourth layer 208.

The layers 102, 104, 206, and 208 can be alternating high index of refraction layers and low index of refraction layers. For example, the first layer 102 and the third layer 206 can be high index of refraction layers and the second layer 104 and the fourth layer 208 can be low index of refraction layers. Alternatively, the first layer 102 and the third layer 206 can be low index of refraction layers and the second layer 104 and the fourth layer 208 can be high index of refraction layers. The first layer 102 and the third layer 206 can be the same or different by way of composition and/or property. For example, the first layer 102 and the third layer 206 can comprise the same or different material compositions, indices of refraction, thicknesses, and/or other parameters. The second layer 104 and the fourth layer 208 can be the same or different by way of composition and/or property. For example, the second layer 104 and the fourth layer 208 can comprise the same or different material compositions, indices of refraction, thicknesses, and/or other parameters. The determination of whether one layer is a high index of refraction layer can be based on a comparison to adjacent layers. For example, the third layer 206 may be a high index of refraction layer with respect to the second layer 104 and may be a low index of refraction layer with respect to the fourth layer 208.

The third layer 206 can comprise a thickness, t₃, and the fourth layer 208 can comprise a thickness, t₄. Each thickness, t₃ and t₄, individually, can be in a range of 10 nm to 300 nm as measured with a TEM, such as, for example, 30 nm to 200 nm, 50 nm to 100 nm, 10 nm to 150 nm, 10 nm to 100 nm, 15 nm to 75 nm, 15 nm to 50 nm, 15 nm to 35 nm, 20 nm to 35 nm, 40 nm to 120 nm, 50 nm to 100 nm, 60 nm to 90 nm, or 70 nm to 90 nm, all as measured with a TEM.

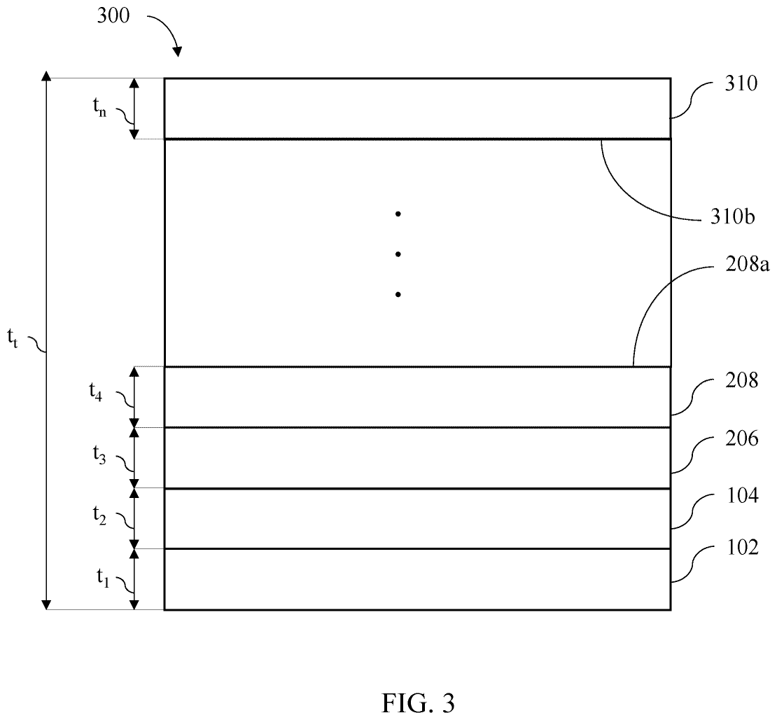

FIG. 3 is a schematic view of a non-conductive pigment 300 comprising “n” number of layers, wherein n is an integer of at least five, such as, for example, at least six, at least seven, at least eight, at least nine, at least ten, at least eleven, or at least twelve. The pigment 300 can comprise the first layer 102, the second layer 104, the third layer 206, the fourth layer 208, such as illustrated in FIG. 2, and an n^{th} layer 310. If n is 5, then the nth layer 310 is adjacent to the fourth layer 208. If n is at least 6, then at least one additional layer is between the fourth layer 208 and the n^{th} layer 310, wherein the number of additional layers between the fourth layer 208 and the n^{th} layer 310 is n minus five. The adjacent layers comprised within the non-conductive pigment 300 are at least partially in direct physical contact with one another. For example, if n is 5, at least a portion or all of a surface 208a of the fourth layer 208 can be at least in direct physical contact with at least a portion or all of a surface 310b of the n^{th} layer 310.

Each of the n layers within the pigment 300 can be alternating high index of refraction layers and low index of refraction layers. Each of the high index of refraction layers in the non-conductive pigment 300 can be the same or different by way of composition and/or property. For example, each of the high index of refraction layers in the non-conductive pigment 300 can comprise the same or different material compositions, indices of refraction, thicknesses, and/or other parameters. Each of the low index of refraction layers in the non-conductive pigment 300 can be the same or different by way of composition and/or property. For example, each of the low index of refraction layers in the non-conductive pigment 300 can comprise the same or different material compositions, indices of refraction, thicknesses, and/or other parameters.

Each of the n layers of the non-conductive pigment 300, individually, can comprise a radar transmissive material, such as, for example, a semiconductor, a dielectric, or a combination thereof. For example, each layer of the non-conductive pigment 300, individually, can comprise silicon, silicon oxide, silicon nitride, zinc telluride, zinc oxide, gallium arsenide, gallium phosphide, iron sulfide, germanium, indium phosphide, indium tin oxide, magnesium fluoride, tantalum oxide, zirconium dioxide, titanium dioxide, a polymer, other semiconductors, other dielectrics, or a combination thereof.

Each of the layers comprised in the non-conductive pigment 300 can comprise a thickness. Each thickness, t₁ through tₙ, individually, can be in a range of 10 nm to 300 nm as measured with a TEM, such as, for example, 30 nm to 200 nm, 50 nm to 100 nm, 10 nm to 150 nm, 10 nm to 100 nm, 15 nm to 75 nm, 15 nm to 50 nm, 15 nm to 35 nm, 20 nm to 35 nm, 40 nm to 120 nm, 50 nm to 100 nm, 60 nm to 90 nm, or 70 nm to 90 nm, all as measured with a TEM.

Without being bound to any particular theory, it is believed that a desirable average visible specular reflectance and a desirable wavelength bandwidth of the non-conductive pigment 100, 200, and/or 300 can be achieved based on the average index of refraction of each layer, the average extinction coefficient of each layer, the thickness of each layer, and total thickness of the pigment, as described in the present disclosure. For example, the non-conductive pigment 100, 200, and/or 300 may have an average visible specular reflectance of at least 80% as measured over a wavelength range of 400 nm to 700 nm using an integrating sphere spectrophotometer, such as, for example, at least 85%, at least 90%, or at least 95%, all as measured over a wavelength range of 400 nm to 700 nm using an integrating sphere spectrophotometer. The pigment may exhibit at least 50% of a maximum of the visible specular reflectance across a wavelength bandwidth of at least 300 nm. As used herein, “average visible specular reflectance” is measured using an integrating sphere spectrophotometer, such as an X-Rite Ci7800 spectrophotometer, and then averaging the reflectance values over wavelengths in a range of 400 nm to 700 nm in 10 nm steps for both a specular component included (SCI) mode and a specular component excluded (SCE) mode, and then subtracting the average reflectance in the SCE mode from the average reflectance in the SCI mode to provide the visible specular reflectance.

The non-conductive pigment 100, 200, and/or 300 can comprise a total thickness, tₜ. The total thickness, tₜ, can be optimized based on the desired application. For example, if the non-conductive pigment will be incorporated into a coating, film, or article with a first dry film thickness, the non-conductive pigment 100, 200, and/or 300 can comprise a total thickness, tₜ, based on the dry film thickness such that a desirable texture (e.g., roughness) of the coating, film, or article can be achieved. For example, the total thickness, tₜ, can be less than the dry film thickness of the coating, film, or article. The total thickness, tₜ, can be no greater than 1 micron as measured by TEM, such as, for example, no greater than 950 nm, no greater than 900 nm, no greater than 800 nm, no greater than 750 nm, no greater than 650 nm, no greater than 600 nm, or no greater than 500 nm, all as measured by TEM. The total thickness, tₜ, can be in the range of 40 nm to 1 micron as measured by TEM, such as, for example, 50 nm to 1 micron, 100 nm to 1 micron, 50 nm to 900 nm, 50 nm to 750 nm, 100 nm to 750 nm, 200 nm to 750 nm, 100 nm to 750 nm, 200 nm to 650 nm, or 300 nm to 600 nm, all as measured by TEM. The total thickness, tₜ, may be no greater than 500 nm as measured by TEM.

The thickness of the coating, film, or article can affect electromagnetic transmission through the coating, film, or article. The dry film thickness of the coating, or film can be measured using a coating thickness measuring tool, such as a FMP40C Dualscope (available from Fischer Technology, Inc.).

The non-conductive pigment 100, 200, and/or 300 can be a flake pigment. For example, the aspect ratio of the non-conductive pigment 100, 200, and/or 300 can be at least 5, such as, for example, at least 10, at least 50, at least 100, at least 500, or at least 1000. The aspect ratio of the non-conductive pigment 100, 200, and/or 300 can affect the luster, sparkle, and/or metallic color of the pigment, and/or a coating, film, and/or article incorporating the non-conductive pigment 100. As used herein, the “aspect ratio” is a ratio of the average lateral size of the pigment divided by the average thickness of the pigment. The average lateral size of a pigment is measured from an optical microscopy image or images of a statistically relevant sampling of the pigment. This is accomplished by measuring the average of the minimum Feret diameter and the maximum Feret diameter of the lateral view for individual particles of the pigment. Then, the average sizes for the particles are averaged over a statistically relevant sampling of the particles of the pigment. In addition to the average lateral size, the standard deviation and the range of the lateral particle size can be obtained.

The non-conductive pigment 100, 200, and/or 300 can comprise an average lateral size in a range of 5 microns to 150 microns, such as, for example, 5 microns to 100 microns, 40 microns to 80 microns, 30 microns to 60 microns, 20 microns to 50 microns, 20 microns to 30 microns, 10 microns to 40 microns, 5 microns to 25 microns, or 15 microns to 30 microns as measured by optical microscopy.

As used herein, “non-conductive” in reference to the pigments of the present disclosure means the pigment has no or low electrical conductivity. For example, the non-conductive pigment 100, 200, and/or 300 can comprise an electrical resistivity of at least 1 Ωcm as measured according to a four-point probe (e.g., Quatek 5601Y sheet resistivity meter) at ambient temperature, such as, for example, at least 50 Ωcm as measured according to a four-point probe at ambient temperature. The four-point probe measurement can be performed according to F. M. Smitts, “Measurement of sheet resistivities with four-point probe”, The Bell System Technical Journal, May 1958, 711-718, which is hereby incorporated by reference. The sample size for utilizing the four-point probe measurement can be at least 1 inch by 1 inch (2.54 cm by 2.54 cm) rectangular sample.

The index of refraction of a layer for the non-conductive pigment 100, 200, and/or 300 can be measured independent of being formed within the non-conductive pigment 100, 200, and/or 300. For example, the layer can be deposited at a target film thickness onto a glass slide with a known index of refraction. Then, the wavelength-dependent index of refraction and extinction coefficient of the layer can be measured over a wavelength range of 400 to 800 nm, at 1 nm intervals, by using an instrument, such as, for example, a F10-RT-UVX from FilmMetrics, a KLA Company, which simultaneously measures film thickness and index of refraction of the layer.

Electrical resistivity and/or average visible specular reflectance of the non-conductive pigment 100, 200, and/or 300 pigment can be measured prior to achieving the desired particle size and/or shape. For example, electrical resistivity and/or average visible specular reflectance of the non-conductive pigment 100, 200, and/or 300 can be measured following creation of a composite used to form the pigment, such as, for example, before the composite is processed to the desired size and/or shape of the pigment. It is understood that the resistivity and/or average visible specular reflectance of the resulting non-conductive pigment after being processed to the desired size and/or shape would have substantially the same electrical resistivity and/or average visible specular reflectance as that of the composite.

The non-conductive pigment 100, 200, and/or 300 can provide a desirable luster, sparkle, and/or metallic color, and because the pigment is non-conductive, the pigment's reduction of radar transmission may be minimized as compared to previous pigments that substantially comprise (e.g., greater than 50%) electrically conductive metals, such as, for example, aluminum flake, copper flake, silver flake, silver-coated copper flake, nickel flake, or other metallic flakes. These previous electrically conductive pigments (e.g., having a bulk electrical conductivity of at least 10⁶ S/m) have an electrical resistivity significantly lower than the pigments according to present disclosure, such as, for example, 7 orders of magnitude lower (such as 10⁶ Ωcm) that can result in a high electromagnetic radiation loss at radar frequency wavelengths. Because the non-conductive pigment 100, 200, and/or 300 is non-conductive, the non-conductive pigment 100, 200, and/or 300 can enable the efficient transmission of electromagnetic radiation, including radar frequency wavelengths. For example, non-conductive pigment 100 and/or films, coatings, and/or articles that incorporate the pigment can enable efficient transmission of electromagnetic radiation in a wavelength in a range of 1 GHz to 300 GHz, such as, for example, 1 GHz to 100 GHz or 76 GHz to 81 GHz. The 76 GHz to 81 GHz wavelength range can be utilized for automotive radar and other radar applications. The non-conductive pigment 100, 200, and/or 300, and/or films, coatings, and/or articles that incorporate the pigment 100, 200, and/or 300 can enable the efficient transmission (e.g., are transparent to) of electromagnetic radiation at a wavelength frequency of 24 GHz and/or 77 GHz.

The non-conductive pigment 100, 200, and/or 300 can comprise at least the first layer 102 and second layer 104 and, optionally, other additive layers. For example, an additive layer may be formed on the outer surface of the non-conductive pigment (e.g., adjacent to surface 102b and/or surface 104a of non-conductive pigment 100). An additive layer may be formed between layers and/or periods of the non-conductive pigment (e.g., between the second layer 104 and the third layer 208 of non-conductive pigment 200). The non-conductive pigment 100, 200, and/or 300 can comprise a surface functionality that imparts a property to the pigment. For example, the surface functionality can facilitate incorporation or dispersion of the non-conductive pigment 100, 200, and/or 300 into a carrier, such as the coating, film, and/or article formulation that gives a desired visual effect, affects rheology, and the like. The non-conductive pigment 100, 200, and/or 300 may have an applied coating with additional functionality, such as, for example, acid functionality to facilitate dispersion of the pigment into a water borne coating. For example, the applied coating may have ester, ether, ketone, urethane, aromaticity, epoxy, or hydroxy (or adducts thereof) linkages or groups to facilitate dispersion of the pigment into a solvent-borne coating or a powder coating. The applied coating may have ester, ether, urethane, vinyl, ethylene, propylene, olefin, amide, acrylate, or carbonate (or adducts thereof) linkages to facilitate incorporation of the pigment into a composition from which a film is made. The applied coating may have carbonate, propylene, amide, ester, urethane, or olefin (or adducts thereof) linkages to facilitate dispersion of the pigment into a composition from which an article is made. Surface functionality may also be introduced through a semiconductor, a dielectric, or a combination thereof included on the outer surface of the non-conductive pigment (e.g., adjacent to surface 102b and/or surface 104a of non-conductive pigment 100).

Surface functionality can affect the rheological properties of the non-conductive pigment 100, 200, and/or 300, such as to facilitate a desired alignment of the pigment in a coating layer, film, and/or article in which the pigment is incorporated. Alignment of the non-conductive pigment 100, 200, and/or 300 in a coating, film, and/or article can optimize the color appearance of the coating, film, and/or article while minimizing radar loss by achieving the desired color while minimizing the amount of non-conductive pigment 100, 200, and/or 300 in the coating, film, and/or article.

The non-conductive pigment 100, 200, and/or 300 may have an organic and/or an inorganic composition. The non-conductive pigment 100, 200, and/or 300 may have a functionality that facilitates incorporation or dispersion of the pigment into a carrier. For example, the non-conductive pigment 100, 200, and/or 300 can comprise species selected to interact with a carrier, such as a coating, film, and/or article formulation, such as by chemical bonding or inter-molecular attractive forces like polar interactions. While one of ordinary skill in the art upon reading the present disclosure would recognize there are numerous ways to incorporate such interactions of the pigment and carrier, some examples include selection of a metal compound that interacts with organic functional groups, such as, for example, the interaction of zinc with sulfur species such as thiol, or the selection of a metal that interacts with acids, such as, for example, the interaction of tin with a carboxylic acid. The non-conductive pigment 100, 200, and/or 300 can include organic-inorganic compounds to facilitate incorporation or dispersion of the pigment into a coating, film, and/or article formulation, such as, for example, alkoxysilanes of the structure (R₁)ₓ—Si—(OR₂)_{y}, where “x” can be in a range of 1 to 3, “y” can be in a range of 1 to 3, and the sum of “x” and “y” can be 4. R¹ can include any organic functionality, including those described above. R² can be an alkyl group having a range of 1 to 10 carbons, such as, for example, 1-3 carbons.

Each of the low refractive index layers of the composite can be deposited by a thin film deposition method, such as, for example, chemical vapor deposition (CVD), initiated chemical vapor deposition (iCVD), physical vapor deposition (PVD), matrix-assisted pulsed laser evaporation (MAPLE), or a combination thereof. Such methods are described in CVD polymers: Fabrication of Organic Surfaces and Devices, Edited by Karen K. Gleason, 2015, Wiley; L. Sun, et. al., “Chemical Vapor Deposition”, Nature Reviews: Methods primers, 1:5, pp. 1-20, (2021); K. K. Gleason, “Nanoscale control by chemically vapour-deposited polymers” Nat. Rev. phys. 2, 347-364 (2020); N. Chen, et. al., “Polymer Thin Films and Surface Modification by Chemical Vapor Deposition: Recent progress”, Annual Review of Chemical and Biomolecular Engineering 7 (1): 373-393 (2016); M. Gupta, K. K. Gleason, “Initiated Chemical Vapor Deposition of Poly(1H,1H,2H,2H-perfluorodecyl Acrylate) Thin Films”, Langmuir, 22, 10047-10052 (2006); A. N. Raegen, et. al., “Ultrastable monodisperse polymer glass formed by physical vapour deposition”, Nature Materials, 19, 1110-1113 (2020); Y. Guo, et. al., “Ultrastable nanostructured polymer glasses” Nature Materials, 11 (4):337-43 (2012), which are hereby incorporated by reference.

Each high refractive index layer and low refractive index layer could be deposited by the same method, such as by PVD and/or CVD. Alternatively, different methods could be employed to alternately deposit a low refractive index layer by a first method, such as, for example, by CVD, or iCVD, followed by deposition of a high refractive index layer by a second method different than the first method, such as, for example, by PVD, and then repeating the deposition of further low and high refractive index layers alternating between the two methods.

The non-conductive pigment 100, 200, and/or 300 can be formed by successively depositing each layer of the pigment to form a composite and processing the composite to form a pigment. To form the composite, the first layer 102, the second layer 104, and optionally any additional layers up to and including the n^{th} layer 310 can be deposited by physical vapor deposition (“PVD”) from targets containing the desired composition of the deposited layer. Various PVD techniques can be used, such as, for example, vacuum sputtering PVD, evaporative PVD, electron beam PVD, or other PVD techniques.

The first layer 102 of the composite can be deposited by PVD directly onto a substrate, such as, for example, onto a support, a release layer that has been applied to the support, or a soluble film that has been applied to the support. The support can comprise a moving web (e.g., a polypropylene film) or drum. The second layer 104 of the composite can be deposited by PVD directly onto the first layer 102 and optionally any additional layers may be successively deposited.

The composite can be removed from the substrate using an air knife assembly. In examples comprising the release layer or soluble film, the release layer or soluble film can be dissolved by treatment or immersion in solvent to release the composite from the support. The process of using a release layer or a soluble film to produce PVD aluminum pigments is described in U.S. Pat. No. 6,317,947, Japanese Patent No. JP10152625, U.S. Patent Publication No. 2015/290713, and “PVD Aluminum Pigments: Superior Brilliance for Coatings & Graphic Arts,” Paint & Coatings Industry, Jun. 1, 2000, all of which are hereby incorporated by reference herein.

Prior to, during, and/or after removal of the composite from the substrate, the composite can be annealed to increase a difference in an average index of refraction between adjacent layers and/or increase the Q value of the high index of refraction layer. The high index of refraction layer can be increased such that a difference in an average index of refraction between adjacent layers as measured over a wavelength of 400 nm to 700 nm is at least 1.5, at least 2, at least 2.4, at least 2.5, at least 2.7, at least 3, or at least 4. The Q value of the high index of refraction layers can be increased to at least 0.930, such as, at least 0.950 or at least 1.000.

Annealing can comprise heating, ultrasonic annealing, and application of electromagnetic radiation in a range of 100 nm to 2000 nm, such as, application of electromagnetic radiation in a range of 100 nm to 400 nm. For example, the application of electromagnetic radiation may include the use of a near-IR laser pulse as described in Large-Scale and Localized Laser Crystallization of Optically Thick Amorphous Silicon Films by Near-IR Femtosecond Pulses”, K. Bronnikov et. al., Materials 2020, 13, 5296, which is hereby incorporated by reference.

In examples where the high index of refraction layer comprises silicon, the silicon can be amorphous silicon prior to the annealing. For example, the depositing of the high index of refraction layer can occur at a temperature of no greater than 800° C., such as, no greater than 700° C., no greater than 600° C., no greater than 500° C., or no greater than 400° C., such that amorphous silicon is deposited.

Amorphous silicon (“a-Si”) lacks a periodic arrangement of the silicon atoms and/or an otherwise ordered structure, whereas a crystalline silicon has a periodic arrangement of the silicon atoms and/or has an ordered crystal lattice over at least a microscopic length, such that the solid is at least polycrystalline, such as described in Solid State Physics, N. W. Ashcroft and N. D. Mermin, ISBN #0-03-083993-9. The annealing can convert the deposited amorphous silicon to crystalline silicon after the annealing. For example, the annealing can rearrange and form a crystal lattice of the silicon atoms in the high index of refraction layers. The average extinction coefficient, kₐᵥₑ, of crystalline silicon is lower than the kₐᵥₑ of amorphous silicon, which can lead to an improvement in the Q value of the high index of refraction layer. Increasing the Q value of the high index of refraction layer can enhance the appearance of a coating formed from the resulting pigment.

The silicon after annealing can comprise at least 50% by weight crystalline silicon, such as, for example, at least 60% by weight crystalline silicon, at least 70% by weight crystalline silicon, at least 80% by weight crystalline silicon, at least 90% by weight crystalline silicon, or at least 99% by weight crystalline silicon, all based on the total weight of the silicon.

Hydrogenated a-Si is a particularly useful form of amorphous silicon that does not require annealing to achieve good Q values, greater than 0.93, for use in a multilayer stack flake pigment. While hydrogenating a-Si can slightly lower nₐᵥₑ, it can dramatically reduce kₐᵥₑ, and thus provide a good Q value, greater than 0.93. Useful values of hydrogenation include from 2% to 12% atomic weight of H, or from 5% to 10% atomic weight of H, or 8% atomic weight of H, or 9% atomic weight of H. Methods of hydrogenation of a-Si films are well-known in the literature, such as by sputtering from an a-Si target in the presence of an argon-hydrogen gas mixture, as described in F. Demichelis et. al., Optical Properties of Hydrogenated Amorphous Silicon, JOURNAL OF APPLIED PHYSICS, February, 611-618, (1986), or as by other methods as described in references such as D. R. Mckenzie et. al., Optical properties of a-Si and a-Si: H prepared by DC magnetron techniques, PHYS. C. SOLID STATE PHYS. 16, 4933-4944 (1983) and F. Edelman et. al., Structure of PECVD Si:H films for solar cell applications, SOLAR ENERGY MATERIALS & SOLAR CELLS 77, 125-143 (2003).

In addition to annealing or as an alternative to annealing, hydrogenation of silicon can reduce absorption in the visible spectrum, leading to an improvement in the Q value of the high index of refraction layer. Hydrogenation of silicon can be performed by depositing the silicon in the presence of hydrogen. For example, the deposition of amorphous silicon or polysilicon can cause dangling bonds in the silicon lattice, resulting in defects that affect the electrical properties of the silicon film (e.g., increase conductivity). Terminating those dangling bonds with hydrogen atoms can reduce defects, reducing the conductivity and thereby lowering the average extinction coefficient, kₐᵥₑ. Hydrogenating the silicon may result in surface passivation of the silicon. Hydrogenating the silicon may result in other effects that also improve the Q value of the high index of refraction layer. Hydrogenation of silicon during the deposition of the high index of refraction layer results in a high index of refraction layer that includes hydrogenated silicon (Si:H). Any of the deposition techniques discussed herein may be used for the deposition of hydrogenated silicon. The hydrogenated silicon may be amorphous hydrogenated silicon (a-Si:H) or hydrogenated polysilicon (poly-Si:H), for example.

Hydrogenated amorphous silicon (a-Si:H) is a particularly useful form of amorphous silicon that does not required annealing to achieve good Q values for use in a multilayer stack flake pigment. While hydrogenating amorphous silicon can slightly lower nₐᵥₑ, it can dramatically reduce kₐᵥₑ, and thus provide a very good Q value. Useful values of hydrogenation include from 2% to 12% atomic weight of H, or from 5% to 10% atomic weight of H, or 8% atomic weight of H, or 9% atomic weight of H. Methods of hydrogenation of a-Si films are well-known in the literature, such as by sputtering from an a-Si target in the presence of an argon-hydrogen gas mixture, as described in F. Demichelis et. al., Optical Properties of Hydrogenated Amorphous Silicon, JOURNAL OF APPLIED PHYSICS, February, 611-618, (1986), or as by other methods as described in references such as D. R. McKenzie et. al., Optical properties of a-Si and a-Si:H prepared by DC magnetron techniques, PHYS. C. SOLID STATE PHYS. 16, 4933-4944 (1983) and F. Edelman et. al., Structure of PECVD Si: H films for solar cell applications, SOLAR ENERGY MATERIALS & SOLAR CELLS 77, 125-143 (2003).

The composite can be collected, for example, via a vacuum into a collection container. The collected composite can be loose when collected and can then be processed to the appropriate size and/or shape (e.g., broken up, ground, milled, or the like, or a combination thereof). For example, the collected composite can be milled into a powder using an ultra-centrifugal mill. The powder can then be passed through sieves to separate the particles into a desired particle size distribution, such as, for example, a desired average lateral size and average thickness.

The composite can be frangible; that is, capable of being broken up, ground, milled, or the like, or combinations thereof. Thus, the composite can be formed into a desired particle size and/or aspect ratio. While not being bound to any particular theory, the inventors believe achieving an aspect ratio of at least 5 can facilitate a desirable luster, sparkle, and/or metallic color in the pigment and/or a coating, film, and/or article in which the pigment is incorporated. The luster may be observed visually with the naked eye.

Coating compositions and coating layers derived therefrom can comprise the non-conductive pigments according to the present disclosure. For example, the coating composition can be an automotive original equipment manufacturer coating composition, an automotive refinish coating composition, an industrial coating composition, an architectural coating composition, a coil coating composition, a packaging coating composition, a marine coating composition, an aerospace coating composition, a consumer electronic coating composition, or the like, or combinations thereof. For example, the coating composition can be applied to an automotive part, such as, for example, a bumper fascia, mirror housings, a fender, a hood, a trunk, a door, or the like, or an aerospace part, such as, for example, a nose cone, a radome, or the like.

The coating composition can comprise the non-conductive pigments according to the present disclosure and a film-forming resin. The film-forming resin can include a resin that forms a self-supporting (e.g., able to remain as a film of material with defined thickness, length and width and remains so without a supporting substrate being present) continuous film upon removal of any diluents or carriers during physical drying and/or cure at ambient or elevated temperature. “Film-forming resin” as used herein refers to resins that are self-crosslinking, resins that are crosslinked by reaction with a crosslinker, forming a solid film by solvent evaporation, mixtures thereof, or the like. The term “film-forming resin” can refer collectively to both a resin and a crosslinker(s).

The film-forming resin can comprise at least one of a thermosetting film-forming resin and/or a thermoplastic film-forming resin. As used herein, the term “thermosetting” refers to resins that “set” irreversibly upon curing or crosslinking, where the polymer chains of the polymeric components are joined together by covalent bonds, which are often induced, for example, by heat or radiation. In various examples, curing or a crosslinking reaction can be carried out under ambient conditions. Once cured or crosslinked, a thermosetting film-forming resin may not melt upon the application of heat and can be insoluble in conventional solvents (e.g., less than 0.001 g of the material can dissolve in 1 g of the given solvent at 20° C. after 24 hours). As used herein, the term “thermoplastic” refers to resins that include polymeric components that are not joined by covalent bonds and thereby can undergo liquid flow upon heating and are often soluble in conventional solvents (e.g., at least 0.1 g of the material can dissolve in 1 g of the given solvent at 20° C. after 24 hours).

Thermosetting coating compositions may include a crosslinking agent that may be selected from, for example, aminoplasts, polyisocyanates (including blocked isocyanates), polyepoxides, beta-hydroxyalkylamides, polyacids, anhydrides, organometallic acid-functional materials, polyamines, polyamides, and mixtures of any of the foregoing.

A film-forming resin may have functional groups that are reactive with the crosslinking agent. The film-forming resin in the coatings described herein may be selected from any of a variety of polymers known in the art. The film-forming resin may be selected from, for example, acrylic polymers, epoxy polymers, polyester polymers, polyurethane polymers, polyamide polymers, polyether polymers, polysiloxane polymers, copolymers thereof, and mixtures thereof. Generally, these polymers may be made by any method known to those skilled in the art. The functional groups on the film-forming resin may be selected from any of a variety of reactive functional groups, including, for example, carboxylic acid groups, amine groups, epoxide groups, hydroxyl groups, thiol groups, carbamate groups, amide groups, urea groups, isocyanate groups (including blocked isocyanate groups), or combinations thereof.

A coating composition can comprise the non-conductive pigment(s) according to the present disclosure in an amount, for example, in a range of 0.1 volume % (vol %)-50 vol %, such as, for example, 0.5 vol %-50 vol % or 2 vol %-25 vol %, based on total volume of a coating layer formed from the coating composition.

The coating composition can additionally comprise aluminum flake. If present, the amount of aluminum flake in the coating composition can be selected to maintain a desirable radar transmission (e.g., no greater than 1.5 dB loss) through the coating composition.

The coating compositions and coating layer formed therefrom can comprise other additives and other pigments than those of the present disclosure. The additives can comprise plasticizers, abrasion-resistant particles, film-strengthening particles, flow control agents, thixotropic agents, rheology modifiers, cellulose acetate butyrate, catalysts, antioxidants, biocides, defoamers, surfactants, wetting agents, dispersing aids, adhesion promoters, clays, hindered amine light stabilizers, ultraviolet (UV) light absorbers and/or stabilizers, stabilizing agents, fillers, organic cosolvents, reactive diluents, grind vehicles, and other customary auxiliaries, or combinations thereof.

The coating composition can be formulated as a solvent-based composition, a water-based composition, or a 100% solid (i.e., non-volatile) composition that does not comprise a volatile solvent (e.g., readily vaporizable at ambient temperatures) or aqueous carrier. The coating composition can be a liquid at a temperature of −10° C. or greater, such as, for example, 0° C. or greater, 10° C. or greater, 30° C. or greater, 40° C. or greater, or 50° C. or greater. The coating composition can be a liquid at a temperature of 60° C. or lower, such as, for example, 50° C. or lower, 40° C. or lower, 30° C. or lower, 10° C. or lower, or 0° C. or lower. The coating composition can be a liquid at a temperature in a range of −10° C. to 60° C., such as, for example, −10° C. to 50° C., −10° C. to 40° C., −10° C. to 30° C., or 0° C. to 40° C. The coating composition can be a liquid at ambient temperature.

A method for applying a coating system to a substrate comprises depositing the coating composition comprising the non-conductive pigment according to the present disclosure over a substrate. The coating composition can be deposited by at least one of spray coating, spin coating, dip coating, roll coating, flow coating, and film coating. In various examples, the coating composition may be manufactured as a preformed film and thereafter applied to the substrate. After depositing the coating composition over the substrate, the coating composition may be allowed to coalesce to form a substantially continuous film on the substrate, and the coating composition can be cured to form a coating layer. The coating composition can be cured at a temperature of −10° C. or greater, such as, for example, 10° C. or greater. The coating composition can be cured at a temperature of 175° C. or lower, such as, for example, 100° C. or lower. The coating composition can be cured at a temperature in a range of −10° C. to 175° C. The curing can comprise a thermal bake (e.g., 80° C. or more, 100° C. or more, 140° C. or more) in an oven.

The substrate can be at least partially coated with the coating composition comprising the non-conductive pigments according to the present disclosure. For example, the coating composition can be applied to 5% or greater of an exterior surface area of the substrate, such as, for example, 10% or greater, 20% or greater, 50% or greater, 70% or greater, 90% or greater, or 99% or greater of an exterior surface area of the substrate. The coating composition comprising the pigments according to the present disclosure can be applied to 100% or lower of an exterior surface area of the substrate, such as, for example, 99% or lower, 90% or lower, 70% or lower, 50% or lower, 20% or lower, or 10% or lower of an exterior surface area of the substrate. The coating layer comprising the pigments according to the present disclosure can be applied to 5% to 100% of an exterior surface area of the substrate, such as, for example, 5% to 99%, 5% to 90%, 5% to 70%, or 50% to 100% of an exterior surface area of the substrate.

The coating layer comprising the non-conductive pigments according to the present disclosure may be incorporated into a single-layer or a multilayer coating stack, such as a multilayer coating stack including at least two coating layers, a first coating layer and a second coating layer underneath at least a portion of the first coating layer. Additional layers, such as, for example, a pretreatment layer, an adhesion promoter layer, a basecoat layer, a mid-coat layer, a topcoat layer (e.g., clear coat, tinted clear coat), a primer layer (e.g., a non-conductive primer layer), or combinations thereof, may be deposited before or after the coating layer comprising the pigments according to the present disclosure. The tinted clear coat can be, for example, a clear coat to which dyes and or pigments are added, including the nano-sized pigment dispersions described in U.S. Pat. Nos. 6,875,800, 7,605,194, 7,612,124, and 7,981,505, all of which are hereby incorporated by reference herein. The tinted clear coat can comprise nano-sized pigment dispersions with an average primary particle size of less than 150 nm as measured with a TEM, such as, for example, less than 100 nm as measured with a TEM. The nano-sized pigment dispersions can have an average primary particle size in a range of 20 nm to 150 nm, such as, for example, 20 nm to 100 nm, 20 nm to 80 nm, 20 nm to 60 nm, or 20 nm to 40 nm. For example, the nano-sized pigments dispersions can have a particle size of 25 nm, 35 nm, or 50 nm. As used herein, average particle size measured with a TEM refers to the Feret diameter of the particle as measured by TEM.

A coating stack for use in automotive applications may comprise an adhesion promoter layer applied to a radar transmissive substrate, a primer layer disposed over the adhesion promoter layer, a basecoat layer comprising the pigments according to the present disclosure disposed over the primer layer, and a clear coat disposed over the basecoat layer. The primer layer may be referred to as basecoat 1 layer (B1) and can have a basecoat 2 layer (B2) applied thereover. The B2 layer can comprise the pigments according to the present disclosure.

The coating compositions and films of the present disclosure can be applied to various substrates in which radar transparency and metallic appearance may be desired. For example, the substrate upon which the coating composition and films of the present disclosure may be applied comprise an automotive substrate, an industrial substrate, an architectural substrate, a coil substrate, a packaging substrate, a marine substrate, an aerospace substrate, a consumer electronic device substrate (e.g., a phone, computer, tablet), or the like, or combinations thereof. “Automotive” as used herein refers to in its broadest sense all types of vehicles, such as, but not limited to, cars, trucks, buses, tractors, harvesters, heavy duty equipment, vans, golf carts, motorcycles, bicycles, railcars, boats of all sizes, and the like. “Aerospace” as used herein refers to in its broadest sense all types of vehicles, such as airplanes, helicopters, drones, and the like.

For example, the substrate can be a radar transmissive substrate. A “radar transmissive substrate” means a substrate having a composition and thickness suitable to transmit electromagnetic radiation at various radar frequencies (e.g., in the range of automotive frequencies of 76 GHz to 81 GHz) with minimal, if any, transmission loss. For example, a radar transmissive substrate can be transparent to the various radar frequencies. That is, a radar transmissive substrate can have a one-way radar transmission loss (OWRTL) of no greater than 5 dB as measured by using a radar transmission system in the radar range of 76 GHz to 81 GHz as described below. Radar transmissive substrates may be nonmetallic and include polymeric substrates, such as plastic, including polyester, polyolefin, polyamide, cellulosic, polystyrene, polyethylene terephthalate, polyacrylic, poly(ethylene naphthalate), polypropylene, polyethylene, nylon, ethylene vinyl alcohol, polylactic acid, other “green” polymeric substrates, poly(ethyleneterephthalate), polycarbonate, polycarbonate acrylobutadiene styrene, polyurethane, thermoplastic olefins, or combinations thereof. The radar transmissive substrate may be filled or unfilled plastic. A filled plastic comprises a plastic with additives such as fibers, such as glass fibers, and/or particles, such as talc. The radar transmissive substrate can comprise glass, wood, or a combination thereof.

Articles of manufacture according to the present disclosure can similarly include vehicle parts, consumer electronic parts, and the like and can be directly printed, for example, by 3D printing or additive manufacturing, from a mixture comprising the pigments of the present disclosure. Such parts would be expected to have a sparkle or metallic luster while also facilitating radar transmission. For example, articles manufactured according to the present disclosure can comprise automotive bumper fascia.

A coating stack as applied to a radar transmissive substrate, such as, for example, in automotive refinish or aerospace applications, may comprise an optional pretreatment layer and/or adhesion promoter layer, a primer layer, a basecoat layer comprising the pigments according to the present disclosure, and a clear coat. A coating stack as applied to a radar transmissive substrate, such as, for example, in automotive refinish, general industrial, or aerospace applications, can comprise an optional pretreatment or adhesion promoter layer, a primer layer, and a direct gloss topcoat layer comprising the pigments according to the present disclosure. Direct gloss topcoat means a coating layer comprising both the color and gloss in one coating that is typically the last applied coating of a coating stack. An additional clear coat can optionally be applied to a direct gloss coating.

A radar system may be positioned proximal to and/or adjacent to the coating, film, and/or article incorporating the pigments according to the present disclosure. The radar system can transmit electromagnetic waves that can traverse through the coating, film, and/or article incorporating the pigments according to the present disclosure. The coating, film, and/or article incorporating the pigments according to the present disclosure can minimally, if at all, reduce the transmission of the electromagnetic waves therethrough such that the electromagnetic radiation can exit the coating, film, and/or article. The electromagnetic radiation that exits the coating, film, and/or article can be used for the detection of an object. For example, the electromagnetic radiation can reflect off the object and return through the coating, film, and/or article and be detected by the radar system.

A method for improving radio detection and ranging in the electromagnetic radiation frequency range of 1 GHz to 300 GHz with radar sensors that are mounted behind effect pigment containing articles is provided. The method may comprise applying a coating composition and/or film comprising the non-conductive pigments according to the present disclosure to a substrate and/or forming the substrate with the non-conductive pigments according to the present disclosure incorporated therein. The improvement can be relative to an effect pigment containing article comprising a conductive pigment.

The non-conductive pigments according to the present disclosure may also suitably be incorporated into a film that, when applied to an article, may provide a desirable optical property, including imparting a metallic luster across visible light wavelengths, and/or providing desirable radio frequency transparency, such as at automotive radar frequencies. The film comprising the pigments of the present disclosure can be formed from any material in which a film suitable for application to a substrate would result. Films according to the present disclosure may be made such that the film would have an appearance similar to a flake-containing coating with a “sparkle-like” quality, rather than a mirrored look. The “sparkle-like” quality evident in coatings containing reflective effect pigments can be evaluated as described in “Complete Appearance Control for Effect Paint Systems,” Paint & Coatings Industry, Mar. 8, 2020. Films can be applied to any substrate, as described below, and may be used in conjunction with another film layer or coating layer.

The film can be a multilayer film comprising at least two layers, including a first layer comprising a thermoset or thermoplastic layer comprising the pigments according to the present disclosure and an adhesive layer. The adhesive layer can be protected with a removable layer or release liner that would be removed prior to application of the film to a substrate. The first layer may be applied to a carrier film that would support the first layer until the first layer is formed, and thereafter the carrier film may optionally be removed. The first layer may be applied to a protective clear film that itself may be on a carrier film. The protective clear film may be thermoset or thermoplastic and would be the top layer when the multilayer film is applied to a substrate via contact of the adhesive layer with the substrate. A layer of the multilayer film may comprise thermoset or thermoplastic polyurethane. Examples of such multilayer films and the process of making such films are described in U.S. Patent Publication No. 2011/0137006, U.S. Patent Publication No. 2017/0058151, U.S. Patent Publication No. 2014/322529, U.S. Patent Publication No. 2004/0039106, U.S. Patent Publication No. 2009/0186198, U.S. Patent Publication No. 2010/0059167, U.S. Patent Publication No. 2019/0161646, U.S. Pat. Nos. 5,114,789, 5,242,751, and 5,468,532, all of which are hereby incorporated by reference. The films of these references can be improved with the incorporation of the pigments according to the present disclosure into a layer of the multilayer film. The first layer of the film may be spray applied, extruded, formed, or polymerized in situ, or otherwise deposited to an adjacent layer of a multilayer film or to a removable layer.

The non-conductive pigments according to the present disclosure may also be suitably incorporated into an article of manufacture, such as, for example, an article formed by injection molding, or an additive manufacturing process, such as, for example, a 3D printing process. In this manner, automotive parts, aerospace parts, consumer electronic parts, and the like can be directly printed from a mixture comprising the pigments of the present disclosure. Such parts would be expected to have a “sparkle-like” or metallic appearance while also facilitating radar transmission. For example, an automotive part can comprise bumper fascia, mirror housings, a fender, a hood, a trunk, a door, and the like. Aerospace parts can comprise a nose cone and a radome. In addition to or alternatively, the articles can be coated with a coating and/or film incorporating the non-conductive pigments according to the present disclosure

In-mold coating (IMC) is an alternative to painting for injection molded plastic parts. IMC can be done by injecting a coating composition according to the present disclosure onto the surface of the article of manufacture while it is still in the mold. The coating then solidifies and adheres to the article. A coating composition or film according to the present disclosure can be applied in mold prior to injection molding of an article of manufacture such that the coating or film is applied to the surface of the molded article or manufacture. Both methods are IMC according to the present disclosure.

When used in injection molding or additive manufacturing in which a part is fabricated by extrusion, the non-conductive pigments according to the present disclosure may be (i) incorporated into the bulk of the material forming the extrusion; (ii) incorporated into a layer of the extrusion, such as a surface layer of the extrusion using coextrusion methods; or (iii) applied to the extrudate by spraying or brushing the pigment onto at least a portion of the exterior surface of the extrudate during fabrication of the part or after the part is fabricated. In a 3D printing coextrusion method, a material containing a pigment according to the present disclosure can be combined with a substrate material in a coextrusion die such that the pigment-containing material forms a layer containing the pigment on the exterior surface of the part. The material forming the substrate and the pigment-containing layer can be coreactive such that compounds within the two layers coreact to form a robust interface. Forming a pigment-containing exterior layer by coextrusion also can avoid having to perform coating or painting processes after the part is fabricated.

Materials and methods using ambient coreactive 3D printing are disclosed, for example, in International Publication No. PCT/US2020/017464, filed on Feb. 10, 2020, and entitled Coreactive Three-Dimensional Printing of Parts; PCT/US2020/017428, filed on Feb. 10, 2020, and entitled Multilayer Systems and Methods of Making Multilayer Systems; and PCT/US2020/017417, filed on Feb. 10, 2020, and entitled Methods of Making Chemically Resistant Sealants, each of which is hereby incorporated by reference herein, where the extrusion materials of these references can include a pigment according to the present disclosure.

The coating compositions and films according to the present disclosure, when coated on substrates to form a coating layer or applied to substrates as a film, may result in substrates having favorable radar transmission performance and desirable aesthetics. The non-conductive pigments of the present disclosure, when incorporated into an article of manufacture, may have similar performance and aesthetics.

A coating and/or film, when applied to a substrate and an article incorporating the non-conductive pigments according to the present disclosure, can comprise a desirable metallic luster as indicated by a L₁₅ value and a flop index. Additionally, a coating and/or film, when applied to a substrate and an article incorporating the pigments according to the present disclosure, can provide a desirable radar transparency as indicated by one-way RADAR transmission loss (OWRTL) as measured a radar transmission system in a radar range of 76 GHz to 81 GHz.

The reflected color attributes of a coating, film, and/or article can be quantified using the International Commission on Illumination (CIE) L₁₅ value as discussed here. CIE L*a*b* color values can be measured using a multi-angle spectrophotometer, such as a BYKmac I, from Altana, at the measurement angles of 15°, 25°, 45°, 75°, and/or 110° relative to the specular direction, with D65 illumination and 10° observer. The L* lightness values at the measurement angle of 15° will be referred to as Lis, at the measurement angle of 25° will be referred to as L25, at the measurement angle of 45° will be referred to as Las, at the measurement angle of 75° will be referred to as L₇₅, and at the measurement angle of 110° will be referred to as L₁₁₀.

A coating, film, and/or article incorporating the non-conductive pigments according to the present disclosure can have a desirable metallic luster. For example, a coating, film, and/or article incorporating the pigments according to the present disclosure can comprise an L₁₅ value of at least 50 as measured using a multi-angle spectrophotometer, such as, for example, at least 60, at least 70, at least 80, at least 90, at least 100, at least 110, at least 120, at least 130, at least 140, at least 150, or at least 160, all as measured using a multi-angle spectrophotometer.

The alignment of the non-conductive pigment is generally acknowledged to affect the lightness value, L*, at 15° and the flop index of a coating, film, and/or article as measured using a multiangle spectrophotometer, such as a BYKmac I spectrophotometer. The flop index of a coating, film, and/or article incorporated the non-conductive pigments according to the present disclosure can be at least 4 as measured using a multi-angle spectrophotometer, such as, for example, at least 5, at least 6, at least 8, at least 10, at least 12, at least 15, at least 17, at least 19, or at least 21, all as measured using a multiangle spectrophotometer.

The flop index of the coating or film on a substrate or the article can be determined using a multi-angle spectrophotometer. The flop index can be quantified from the L* values using the CIE L*a*b* color space measured using a multi-angle spectrophotometer, such as a BYKmac I spectrophotometer, with D65 illumination and 10° observer. As used herein, the term “flop index” is defined according to “Observation and Measurement of the Appearance of Metallic Materials—Part 1—Macro Appearance,” C. S. McCamy, Color Research And Application, Volume 21, Number 4, August 1996, pp. 292-304, which is hereby incorporated by reference. Namely, the flop index is defined according to Equation 1, set forth below.

$$Flop Index = 2.69 {( {L}_{15} - {L}_{110} )}^{1.11} / {( {L}_{45} )}^{0.86} \qquad Equation 1$$

wherein:
L₁₅ is CIE L* value measured at the aspecular angle of 15°;
L₄₅ is CIE L* value measured at the aspecular angle of 45°; and
L₁₁₀ is CIE L* value measured at the aspecular angle of 110°.

OWRTL can quantify the radar loss, if any, of a coating, film, and/or article incorporating the non-conductive pigments according to the present disclosure. OWRTL can be measured in dB using a radar transmission system, such as a focused beam radar measurement system assembled from the following components: a signal generator (SMA100B (with SMAB-B92/SMAB-B120)) available from Rohde & Schwarz, a six times multiplier (SMZ90) available from Rohde & Schwarz, a thermal waveguide power sensor (NRP90TWG) available from Rohde & Schwarz, two E-band spot-focusing lens antennas with 1.7 inch (4.318 cm) focal length (SAQ-813017-12-S1) available from Sage Millimeter, and a Coax cable, 3.5 mm Male to 3.5 mm Male (FM160FLEX) available from Fairview Microwave. The two lenses are connected to the emitter (six times multiplier) and the detector (the power sensor), with the lenses facing each other. The lenses are aligned along their axes, with their separation being about twice their focal length (3.4 inches (8.636 cm)) and with this separation adjusted to ensure maximum free space radar transmission, with no sample between the lenses. Then, with this setup, a sample may be measured by securing it between the lenses, with the surface of the sample that is facing the detecting lens being placed at a distance of 45 mm from the detecting lens (1.8 mm in front of the focal point of the detecting lens). If the sample is a thermoplastic polyolefin (TPO) panel having a coating or film thereon, the OWRTL may be measured by securing it between the lenses, with the surface of the coating or film that is being measured placed facing the detecting lens, at a distance of 45 mm from the detecting lens. The radar transmission loss in dB is calculated with Equation 2.

$$OWRTL ( dB ) = free space transmission ( dBm ) - sample transmission ( dBm ) . \qquad Equation 2$$

A coating, film, and/or article incorporating the non-conductive pigments according to the present disclosure can comprise a desirable radar transparency. For example, a coating, film, and/or article incorporating a non-conductive pigment according to the present disclosure can comprise an OWRTL of no greater than 1.5 dB as measured using a radar transmission system in the frequency range of 76 GHz to 81 GHz, such as, for example, no greater than 1.3 dB, no greater than 1.0 dB, no greater than 0.7 dB, no greater than 0.5 dB, or no greater than 0.3 dB, all as measured using a radar transmission system in the frequency range of 76 GHz to 81 GHz. The dry film thickness (DFT) selected for the coating system should be the same used for measuring the Lis value, the flop index, and the OWRTL.

For example, the DFT can be no greater than 255 microns as measured by optical microscopy, such as, for example, no greater than 203 microns, no greater than 200 microns, no greater than 150 microns, or no greater than 103 microns, all as measured by optical microscopy. The DFT can be in the range of 5 microns to 255 microns as measured by optical microscopy, such as, for example, 5 to 203 microns, or 8 to 103 microns, all as measured by optical microscopy.

A coating and/or film, when applied to a substrate, and an article incorporating the pigment according to the present disclosure can comprise:
an L₁₅ value of at least 70 as measured using a multi-angle spectrophotometer;
a flop index of at least 10 as measured using a multi-angle spectrophotometer; and
OWRTL of no greater than 1.5 dB as measured by a radar transmission system in a radar range of 76 GHz to 81 GHz.

In the advancement of autonomous driving technology, aluminum flakes in coatings are not only problematic for radar sensing through plastic bumper fascia, but also for lidar sensors. The problem is different than for radar sensors. In the case of lidar, a lidar enabled vehicle has difficulty identifying other vehicles if those other vehicles have coatings containing aluminum flake. The trouble is in how specularly reflective aluminum flakes are at the near infrared (NIR) wavelengths common to lidar detectors, such as 905 nm and 1550 nm. NIR light from the lidar device shines out from the devices to reflect off the surrounding vehicles. These lidar beams reflect predominantly in a specular fashion from aluminum-flake-containing coatings, so that only for those lidar beams that hit the coating at normal or very close to normal incidence will the beams reflect back to the lidar sensor and be detected. Other beams not at normal incidence will reflect specularly at the same angle as the incidence angle, but away from the incident direction, and therefore, cannot be detected by the lidar sensor. This significantly hinders the ability of lidar enabled vehicles to detect and properly identify the surrounding vehicles.

The pigment flakes illustrated herein solve this problem, because even though they have high reflectance in the visible part of the electromagnetic spectrum, they have low reflectance in the NIR portion of the electromagnetic spectrum, including at the common lidar wavelengths. Thus, coatings formulated with the pigment flakes illustrated herein, not only enable improved radar sensing, but they also enable improved lidar sensing for autonomous and advanced driving assistance features in vehicles.

To be more specific, in coatings containing the pigment flakes illustrated herein, the NIR light from lidar sensors passes through the pigment flakes and reaches the coating below the one containing the pigment flakes illustrated herein. For instance, consider a standard vehicle coatings stack comprising a primer layer, a base coat layer (containing the pigments illustrated herein), and a clear coat layer. The lidar beam passes through the clear coat, passes through the base coat, and is diffusely reflected by the primer layer. Especially good primers would be those that contain white pigments, such as titanium dioxide pigments and NIR transparent colorants, but lacking carbon black pigments as described in US patent application number 20180120435, which is incorporated herein by reference in its entirety. Thus, the NIR lidar beams transmit through the flake-containing base coat, diffusely reflect off the primer layer, transmit back through the base coat, to travel back to the lidar sensor, where they are detected.

As used herein, unless otherwise expressly specified, all numbers, such as those expressing values, ranges, amounts, or percentages, may be read as if prefaced by the word “about,” even if the term does not expressly appear. Any numerical range recited herein is intended to include all sub-ranges subsumed therein. The plural encompasses the singular and vice versa. For example, while the disclosure has been described in terms of “a” pigment, “a” substrate, “a” semiconductor, “a” dielectric, and the like, more than one of these and other components, including mixtures, can be used. Also, as used herein, the term “polymer” is meant to refer to prepolymers, oligomers, and both homopolymers and copolymers; and the prefix “poly” refers to two or more. When ranges are given, any endpoints of those ranges and/or numbers within those ranges can be combined with the scope of the present disclosure. “Including,” “such as,” “for example,” and like terms mean “including/such as/for example but not limited to.” The terms “acrylic” and “acrylate” are used interchangeably (unless to do so would alter the intended meaning) and include acrylic acids, anhydrides, and derivatives thereof, lower alkyl-substituted acrylic acids, e.g., C₁-C₂ substituted acrylic acids, such as methacrylic acid, ethacrylic acid, etc., and their C₁-C₆ alkyl esters and hydroxyalkyl esters, unless clearly indicated otherwise.

As used herein, the terms “on,” “applied on/over,” “formed on/over,” “deposited on/over,” “overlay,” and “provided on/over” mean formed, overlay, deposited, or provided on but not necessarily in contact with the surface. For example, a coating layer “formed over” a substrate does not preclude the presence of one or more other coating layers of the same or different composition located between the formed coating layer and the substrate.

As used in this specification, the terms “cure” and “curing” refer to the chemical crosslinking of components in a coating composition applied as a coating layer over a substrate. Accordingly, the terms “cure” and “curing” do not encompass solely physical drying of coating compositions through solvent or carrier evaporation. In this regard, the term “cured,” as used in this specification, refers to the condition of a coating layer in which a component of the coating composition forming the layer has chemically reacted to form new covalent bonds in the coating layer (e.g., new covalent bonds formed between a binder resin and a curing agent).

As used in this specification, the term “formed” refers to the creation of an object from a composition by a suitable process, such as, curing. For example, a coating formed from a curable coating composition refers to the creation of a single or multiple layered coating or coated article from the curable coating composition by curing the coating composition under suitable process conditions.

### EXAMPLES

The present disclosure will be more fully understood by reference to the following examples, which provide illustrative non-limiting aspects of the disclosure. It is understood that the disclosure described in this specification is not necessarily limited to the examples described in this section.

As used herein, the term “parts” refers to parts by weight unless indicated to the contrary.

### Calculation and Test Methods

Theoretical Visible Specular Reflectance Method and Theoretical Visible Specular

Transmittance Method: Theoretical calculations of visible specular reflectance and transmittance as functions of wavelength referenced in the following examples were completed using equations and methods known in the art. For example, see MAX BORN AND EMIL WOLF, PRINCIPLES OF OPTICS, Wave Propagation In a Stratified Medium, Chapter 1, Section 1.6 (7th (expanded) Ed.); and EUGENE HECHT, OPTICS, Applications of Single and Multilayer Films, Chapter 9, Section 9.7 (2nd Ed.), both of which are herein incorporated by reference. These methods compute the electric and magnetic fields above and below a stack of layers of given thicknesses using the refractive index and extinction coefficient for each of the layers. This can be performed at any given wavelength for which the refractive index and extinction coefficient values are known. From this, the reflectance and transmittance coefficients and finally the % reflectance (% R), % transmittance (% T), and % absorptance (% A) can be calculated at each desired wavelength. These methods allow the angle of incidence of the incoming electromagnetic waves to be specified. All calculations done here were computed at normal incidence, meaning the angle of the incident electromagnetic waves relative to the normal to the surface of the stack is zero degrees. All calculations done here used refractive index and extinction coefficient values of each material as a function of wavelength, either obtained from the references shown below Table 2, and when the data was not given at 1 nm intervals, the data values were obtained at 1 nm intervals by interpolation. Thus, when calculated values were then averaged over the visible region from 400-700 nm, such as an average refractive index, nₐᵥₑ, an average extinction coefficient, kₐᵥₑ, or an average reflectance, transmittance, or absorptance, the wavelength dependent values were averaged over all the values at 1 nm intervals from 400 to 700 nm. This calculated average visible specular reflectance corresponds to, and can be equated to, a measured average visible specular reflectance.

As seen in Table 2, when nₐᵥₑ has a higher value, the reflectance tends to be higher. However, if kₐᵥₑ is higher, it tends to increase the absorptance and therefore reduce reflectance. We have found that a Q value for the higher refractive index layer can discriminate materials that provide a sufficient amount of reflectance accompanied with broadband reflectance.

The Theoretical Visible Specular Reflectance Method and the Theoretical Visible Specular Transmittance Method calculate the reflectance and transmittance of various theoretical pigments/and or stacks as a function of wavelength. In particular, using the wavelength dependent values for refractive index and extinction coefficient for a stack of at least two layers, the thickness of the high refractive index layers and the low refractive index layers were varied in order to maximize the calculated average visible specular reflectance within the visible wavelength range of 400-700 nm (herein referred to as % R). Stacks with these optimized layered structures to maximize the % R are tabulated in Tables 2-5. In the examples below, the average index of refraction is referred to as nₐᵥₑ and the average extinction coefficient is referred to as kₐᵥₑ. In these examples, the values nₐᵥₑ and kₐᵥₑ for a particular material were calculated using known values of the index of refraction and extinction coefficient for that material at various wavelengths. These known values were then interpolated to obtain the index of refraction and extinction coefficient for the material at each wavelength from 400 nm to 700 nm at 1 nm intervals. The interpolated values were then averaged to obtain nₐᵥₑ and kₐᵥₑ. The known values of the index of refraction and extinction coefficient were found in the references shown below Tables 2-5.

Panel Coating Method: Coatings formulated as described herein were sprayed in one or more coats to a dry film thickness (DFT) of 0.1-4.0 mils (8-100 microns) onto a TPO panel (Lyondell Basell HiFax TRC779X, 4 inches×12 inches×0.118 inch, available from Standard Plaque Inc.). Prior to spraying the formulated coatings, the TPO panel was cleaned with SU4901 Clean and Scuff Pad, wiped with SU4902 Plastic Adhesion Wipe, and sprayed with SUA4903 Advanced Plastic Bond (all available from PPG Industries, Inc.). Once the SUA4903 was dry (approximately 5-15 min after application at ambient temperature) a sealer (DAS3025/DCX3030/DT885 mixed at 3/1/1 by volume, Acrylic Urethane Scaler/Undercoat Hardener/Warm Temperature Reducer, all available from PPG Industries, Inc.) was applied in one coat with a SATAjet BF100 spray gun with a 1.3 mm nozzle and 28 psi (193 kPa) air pressure at the gun. The sealer was allowed to dry and cure for 15-60 min before the formulated coatings of the examples herein were applied. The example coating mixture was agitated prior to spray application by stirring. A high volume lower pressure (HVLP) gravity fed spray gun (SATAjet 1500 B HVLP SoLV) with a 1.3 mm nozzle and 28 psi (193 kPa) air pressure at the gun was used to spray apply the coatings with flash between multiple coats for 5-10 minutes and would be considered dry when the coatings were tack free (e.g., a condition of a coating where its surface ceases to be sticky) (typically 15-40 minutes at 20° C.). The panel was then coated with a protective clearcoat, in particular, PPG DELTRON solvent borne clearcoat (Velocity Premium Clearcoat; DC 4000, available from PPG Industries, Inc.) was prepared by mixing DC 4000 with hardener (DCH 3085) in a 4:1 v/v ratio. Clearcoats were applied in two coats over tack-free coating layers of the examples of the present disclosure using a HVLP gravity fed spray gun (Anest Iwata WS400) with a 1.3 mm nozzle and 28 psi (193 kPa) at the gun. Clearcoats were applied using two coats with a 5-10 minute flash (e.g., to remain at ambient temperature and allow for evaporation of some of the volatile content of a coating) between coats. Clearcoats were cured as described in the publicly available technical data sheet, such as in a convection oven at 60° C. for 20 minutes or at 21° C. for 4-6 hours. All dry film thicknesses (DFT) were measured by spraying 0.020×2×12 inch steel film check panels (available from Q-Lab Corporation, Westlake, Ohio, Order Number SP-105293) at the same time as the other panels and using a coating thickness measuring tool, such as a FMP40C Dualscope (available from Fischer Technology, Inc.), to measure the cured coating thickness on the film check panels.

### Prophetic Examples 1-2: Theoretical Aluminum Pigment Flakes

Examples 1-2 represent theoretical aluminum flake pigments. Each pigment comprises a single layer of aluminum. Table 1 below illustrates various values that were calculated for each aluminum layer thickness. Namely, for each of Examples 1-2, Table 1 includes: the material used; the average refractive index “nₐᵥₑ” and average extinction coefficient “kₐᵥₑ”; the thickness “t” of the layer; the average visible specular reflectance “% R” of the aluminum layer over the visible range; the average visible specular transmittance “% T” of the aluminum layer over the visible range; the average visible specular absorptance “% A” of the aluminum layer over the visible range; the Q value for aluminum; and the approximate wavelength bandwidth “Δλ” across which the aluminum layer exhibits at least 50% of the maximum reflectance. In the theoretical calculations, the values of the refractive index indices and extinction coefficients above and below the aluminum layer were chosen to be n=1.0 and k=0 (for above the aluminum layer) and n=1.5 and k=0 (for below the aluminum layer), to simulate measuring the aluminum layer deposited onto glass in air. The known refractive index and extinction coefficient values used to calculate nₐᵥₑ and kₐᵥₑ were taken from the references cited below. The values of average visible specular reflectance % R and average visible specular transmittance % T were calculated according to the Theoretical Visible Specular Reflectance Method and the Theoretical Visible Specular Transmittance Method, respectively. The value of average visible specular absorptance % A was calculated by subtracting the average visible specular reflectance % R and average specular transmittance % T from 100 (i.e. % A=100−% R−% T). Table 1 theoretically shows that there is no change to the % R, % T, and % A of an aluminum layer once it is 60 nm thick to the precision reported here.

TABLE 1

| | | | | t | | | | | Δλ |
|---|---|---|---|---|---|---|---|---|---|
| Example | Material | nₐᵥₑ | kₐᵥₑ | (nm) | % R | % T | % A | Q | (nm) |
| 1 | Al | 1.076 | 6.590 | 60.0 | 91.4 | 0.0 | 8.6 | −1.082 | >300 |
| 2 | A1 | 1.076 | 6.590 | 200.0 | 91.4 | 0.0 | 8.6 | −1.082 | >300 |

### Prophetic Examples 3-37: Theoretical Multi-Layer Stacks Made into Pigment Flakes

Examples 3-37 represent theoretical multi-layer stacks of 2, 6, or 8 alternating layers. Each theoretical multi-layer stack was built with a different material deposited in layers alternating with layers of SiO₂. Table 2 below illustrates various values that were calculated for each theoretical two-layer stack. Namely, for each of Examples 3-12, Table 2 includes: the material used in layers alternating with layers of SiO₂; the average refractive index “nₐᵥₑ” and average extinction coefficient “kₐᵥₑ” for that material; the thickness “L_{H}” of the layers comprising that material; the thickness “L_{L}” of the layers comprising SiO₂; the average visible specular reflectance “% R” of the theoretical stack over the visible range; the average visible specular transmittance “% T” of the theoretical stack over the visible range; the average visible specular absorptance “% A” of the theoretical stack over the visible range; the difference “An” between the nₐᵥₑ for the chosen material and the nₐᵥₑ for SiO₂; the Q value for that material; and the approximate wavelength bandwidth “Δλ” across which the stack exhibits at least 50% of the maximum reflectance. In the theoretical calculations, the values of the refractive index indices and extinction coefficients above and below all the stacks were chosen to be n=1.0 and k=0 (for above the stack) and n=1.5, and k=0 (for below the stack), to simulate measuring the multi-layer stacks deposited onto glass in air. Table 3 is similar to Table 2 but with a six-layer alternating stack. Table 4 is similar to Table 2 but with an eight-layer alternating stack. Table 5 is similar to Table 2, but Table 5 includes TiO₂ used in layers alternating with layers of SnO₂; using the same average refractive index “nₐᵥₑ” and average extinction coefficient “kₐᵥₑ” for those materials as shown in Tables 2-4, and shows the thickness “L_{H}” of the layers comprising that TiO₂, and the thickness “L_{L}” of the layers comprising SnO₂.

In Examples 3-33, the values of nₐᵥₑ and kₐᵥₑ are calculated as described above. The known refractive index and extinction coefficient values used to calculate nₐᵥₑ and kₐᵥₑ were taken from the references cited below Table 2. The values of LH and LL for each stack were selected based on the thickness that provided the maximum average visible specular reflectance % R. The values of average visible specular reflectance % R and average visible specular transmittance % T were calculated according to the Theoretical Visible Specular Reflectance Method and the Theoretical Visible Specular Transmittance Method, respectively. The value of average visible specular absorptance % A was calculated by subtracting the average visible specular reflectance % R and average specular transmittance % T from 100 (i.e. % A=100−% R−% T).

TABLE 2
Two-Layer Stacks Alternating the Stated material with SiO₂.

| | | | | L_{H} | L_{L} | t | | | | | | Δλ |
|---|---|---|---|---|---|---|---|---|---|---|---|---|
| Example | Material | nₐᵥₑ | kₐᵥₑ | (nm) | (nm) | (μm) | % R | % T | % A | Δn | Q | (nm) |
| 3 | ZnO | 1.634 | 0.009 | 77.3 | 96.4 | 0.174 | 8.6 | 89.8 | 1.6 | 0.173 | 0.673 | >300 |
| 4 | SnO₂ | 1.969 | 0.018 | 63.0 | 97.1 | 0.160 | 19.3 | 78.3 | 2.4 | 0.508 | 0.741 | >300 |
| 5 | ZnS | 2.423 | 0.043 | 52.4 | 95.9 | 0.148 | 34.0 | 62.0 | 4.0 | 0.962 | 0.814 | >300 |
| 6 | r-TiO₂ | 2.986 | 0.000 | 44.6 | 94.6 | 0.139 | 46.1 | 53.9 | 0.0 | 1.525 | 0.898 | >300 |
| 7 | ZnTe | 3.197 | 0.185 | 38.9 | 101.8 | 0.141 | 49.6 | 40.8 | 9.6 | 1.736 | 0.896 | >300 |
| 8 | a-Si:H | 4.170 | 0.379 | 29.9 | 104.4 | 0.134 | 62.3 | 26.4 | 11.3 | 2.710 | 0.968 | >300 |
| 9 | GaAs | 4.197 | 0.494 | 29.8 | 106.8 | 0.137 | 61.2 | 25.3 | 13.4 | 2.736 | 0.956 | >300 |
| 10 | c-Si | 4.237 | 0.077 | 28.6 | 99.7 | 0.128 | 66.7 | 30.6 | 2.7 | 2.776 | 1.010 | >300 |
| 11 | a-Si | 4.335 | 0.915 | 29.2 | 112.0 | 0.141 | 60.3 | 18.5 | 21.2 | 2.874 | 0.918 | >300 |
| 12 | FeS₂ | 4.416 | 0.061 | 29.5 | 92.4 | 0.122 | 72.1 | 26.0 | 1.9 | 2.955 | 1.025 | >300 |

For SiO₂, nₐᵥₑ = 1.461 and kₐᵥₑ = 0.

TABLE 3
Six-Layer Stacks Alternating the Stated material with SiO₂.

| | | | | L_{H} | L_{L} | t | | | | | | Δλ |
|---|---|---|---|---|---|---|---|---|---|---|---|---|
| Example | Material | nₐᵥₑ | kₐᵥₑ | (nm) | (nm) | (μm) | % R | % T | % A | Δn | Q | (nm) |
| 13 | ZnO | 1.634 | 0.009 | 84.1 | 108.4 | 0.578 | 13.0 | 82.2 | 4.7 | 0.173 | 0.673 | 183 |
| 14 | SnO₂ | 1.969 | 0.018 | 68.8 | 102.2 | 0.513 | 37.3 | 55.5 | 7.2 | 0.508 | 0.741 | 190 |
| 15 | ZnS | 2.423 | 0.043 | 52.0 | 95.7 | 0.443 | 63.4 | 26.4 | 10.2 | 0.962 | 0.814 | 242 |
| 16 | r-TiO₂ | 2.986 | 0.000 | 43.1 | 92.4 | 0.406 | 82.6 | 17.4 | 0.0 | 1.525 | 0.898 | 277 |
| 17 | ZnTe | 3.197 | 0.185 | 35.6 | 104.3 | 0.419 | 77.0 | 7.3 | 15.7 | 1.736 | 0.896 | >300 |
| 18 | a-Si:H | 4.170 | 0.379 | 25.8 | 111.4 | 0.412 | 84.1 | 2.1 | 13.7 | 2.710 | 0.968 | >300 |
| 19 | GaAs | 4.197 | 0.494 | 25.0 | 115.0 | 0.420 | 81.9 | 1.5 | 16.6 | 2.736 | 0.956 | >300 |
| 20 | c-Si | 4.237 | 0.077 | 24.6 | 103.9 | 0.385 | 93.7 | 2.8 | 3.5 | 2.776 | 1.010 | >300 |
| 21 | a-Si | 4.335 | 0.915 | 24.6 | 119.6 | 0.433 | 75.5 | 0.7 | 23.9 | 2.874 | 0.918 | >300 |
| 22 | FeS₂ | 4.416 | 0.061 | 28.2 | 95.8 | 0.372 | 96.6 | 0.7 | 2.7 | 2.955 | 1.025 | >300 |
| 23 | c-Si | 4.237 | 0.077 | Varied* | Varied* | 0.412 | 93.4 | 3.2 | 3.3 | 2.776 | 1.010 | >300 |

| | | L_{H} | L_{L} | t | | | | |
|---|---|---|---|---|---|---|---|---|
| Example | Material | (nm) | (nm) | (μm) | % R | % T | % A | C* |
| 20 | c-Si | 24.6 | 103.9 | 0.385 | 93.7 | 2.8 | 3.5 | 2.07 |
| 23 | c-Si | Varied* | Varied* | 0.412 | 93.4 | 3.2 | 3.3 | 1.75 |

| | L |
|---|---|
| Material | (nm) |
| c-Si | 19.8 |
| SiO₂ | 99.9 |
| c-Si | 24.5 |
| SiO₂ | 93.0 |
| c-Si | 38.1 |
| SiO₂ | 136.2 |

For SiO₂, nₐᵥₑ = 1.461 and kₐᵥₑ = 0.
C* is the CIE chroma value calculated from the visible reflectance spectra for these two multi-layer stacks.
*Varied

TABLE 4
Eight-Layer Stacks Alternating the Stated material with SiO₂.

| | | | | L_{H} | L_{L} | | | | | | | Δλ |
|---|---|---|---|---|---|---|---|---|---|---|---|---|
| Example | Material | nₐᵥₑ | kₐᵥₑ | (nm) | (nm) | t (μm) | % R | % T | % A | Δn | Q | (nm) |
| 24 | ZnO | 1.634 | 0.009 | 86.7 | 113.0 | 0.799 | 14.4 | 79.3 | 6.3 | 0.173 | 0.673 | 142 |
| 25 | SnO₂ | 1.969 | 0.018 | 70.6 | 107.3 | 0.711 | 41.5 | 49.2 | 9.3 | 0.508 | 0.741 | 168 |
| 26 | ZnS | 2.423 | 0.043 | 52.1 | 105.6 | 0.631 | 66.6 | 21.1 | 12.3 | 0.962 | 0.814 | 235 |
| 27 | r-TiO₂ | 2.986 | 0.000 | 44.0 | 101.0 | 0.580 | 84.7 | 15.3 | 0.0 | 1.525 | 0.898 | 272 |
| 28 | ZnTe | 3.197 | 0.185 | 35.4 | 110.6 | \|0.584 | 78.1 | 4.0 | 17.9 | 1.736 | 0.896 | 283 |
| 29 | a-Si:H | 4.170 | 0.379 | 25.9 | 111.4 | 0.549 | 84.5 | 0.8 | 14.6 | 2.710 | 0.968 | >300 |
| 30 | GaAs | 4.197 | 0.494 | 24.8 | 116.1 | 0.564 | 82.3 | 0.4 | 17.3 | 2.736 | 0.956 | >300 |
| 31 | c-Si | 4.237 | 0.077 | 24.1 | 104.3 | 0.514 | 94.7 | 1.5 | 3.9 | 2.776 | 1.010 | >300 |
| 32 | a-Si | 4.335 | 0.915 | 24.5 | 120.7 | 0.581 | 75.6 | 0.1 | 24.3 | 2.874 | 0.918 | >300 |
| 33 | FeS₂ | 4.416 | 0.061 | 27.7 | 98.2 | 0.503 | 97.1 | 0.2 | 2.7 | 2.955 | 1.025 | >300 |

For SiO₂, nₐᵥₑ = 1.461 and kₐᵥₑ = 0.

TABLE 5
Multi-Layer Stacks of the Stated Number of Layers Alternating r-TiO₂ with SnO₂.

| | # of | L_{H} | L_{L} | t | | | | | Δλ |
|---|---|---|---|---|---|---|---|---|---|
| Example | Layers | (nm) | (nm) | (μm) | % R | % T | % A | Δn | (nm) |
| 34 | 2 | 45.4 | 167.9 | 0.213 | 38.1 | 57.4 | 4.6 | 1.017 | >300 |
| 35 | 4 | 46.8 | 59.6 | 0.213 | 48.6 | 48.0 | 3.4 | 1.017 | >300 |
| 36 | 6 | 48.3 | 75.1 | 0.370 | 55.2 | 37.2 | 7.6 | 1.017 | 225 |
| 37 | 8 | 48.4 | 81.9 | 0.521 | 59.0 | 30.8 | 10.1 | 1.017 | 183 |

TABLE 6
Summary of lidar-enabling characteristics of some of the previously
discussed theoretical multilayer stacks made into pigment flakes.

| | | L_{H} | L_{L} | t | | | % R @ | % T @ | % R @ | % T @ |
|---|---|---|---|---|---|---|---|---|---|---|
| Example | Material | (nm) | (nm) | (μm) | % R | % T | 905 nm | 905 nm | 1550 nm | 1550 nm |
| 18 | a-Si:H | 25.8 | 111.4 | 0.412 | 84.1 | 2.1 | 21.0 | 75.5 | 4.9 | 93.4 |
| 20 | c-Si | 24.6 | 103.9 | 0.385 | 93.7 | 2.8 | 24.7 | 74.9 | 3.9 | 96.1 |
| 21 | a-Si | 24.6 | 119.6 | 0.433 | 75.5 | 0.7 | 2.2 | 88.7 | 3.3 | 96.7 |
| 2 | Al | 200 | NA | 0.200 | 91.4 | 0.0 | 89.4 | 0.0 | 97.5 | 0.0 |

% R @ 905 nm, % T @ 905 nm, % R @ 1550 nm, and % T @ 1550 nm were calculated using the same methods as in the Theoretical Visible Specular Reflectance Method and Theoretical Visible Specular Transmittance Method, except these % reflectance and % transmittance values were calculated at the specific (not averaged) NIR (instead of visible) wavelengths of 905 nm and 1550 nm. NA=not applicable.

### References for Optical Constants (Refractive Index (n) and Extinction Coefficient (k), as Functions of Wavelength):

SiO₂—I. H. Malitson, Interspecimen Comparison of the Refractive Index of Fused Silica, 55 JOURNAL OF THE OPTICAL SOCIETY OF AMERICA, Issue 10, 1205-1209 (1965).
c-Si—G. E. Jellison Jr. Optical functions of silicon determined by two-channel polarization modulation ellipsometry, OPT. MAT. 1, 41-47 (1992). C. Schinke, et. al., Uncertainty analysis for the coefficient of band-to-band absorption of crystalline silicon. AIP ADVANCES 5, 67168 (2015). E. Shkondin, et. al., Large-scale high aspect ratio Al-doped ZnO nanopillars arrays as anisotropic metamaterials, OPT. MATER. EXPRESS 7, 1606-1627 (2017). H. H. Li, Refractive index of silicon and germanium and its wavelength and temperature derivatives, J. PHYS. CHEM. Ref. Data 9, 561-658 (1993).
SnO2—J. Gong, X. Wang, X. Fan, R. Dai, Z. Wang, Z. Zhang, and Z. Ding, Temperature dependent optical properties of SnO2 film study by ellipsometry, OPTICAL MATERIALS EXPRESS, Vol. 9, Issue 9, pp. 3691-3699 (2019).
ZnO—C. Stelling, C. R. Singh, M. Karg, T. A. F. König, M. Thelakkat, M. Retsch, Plasmonic nanomeshes: their ambivalent role as transparent electrodes in organic solar cells, 7 SCIENTIFIC REPORTS 42530 (2017).
r-TiO₂ (rutile TiO₂)—J. R. Devore, Refractive indices of rutile and sphalerite, J. OPT. SOC. AM. 41, 416-419 (1951).
ZnS—S. Ozaki and S. Adachi, Optical constants of cubic ZnS, 32 JAPANESE JOURNAL OF APPLIED PHYSICS, 5008-5013 (1993).
ZnTe—K. Sato and S. Adachi, Optical properties of ZnTe, 73 JOURNAL OF APPLIED PHYSICS 926-931 (1993).
GaAs—G. E. Jellison Jr., Optical functions of GaAs, GaP, and Ge determined by two-channel polarization modulation ellipsometry, 1 OPTICAL MATERIALS 151-160 (1992) c-Si—G. E. Jellison Jr., Optical functions of silicon determined by two-channel polarization modulation ellipsometry, 1 OPTICAL MATERIALS 41-47 (1992).
a-Si—Handbook of Optical Constants of Solids, Edward D. Palik, ed. Academic Press, Boston, 1985. D. T. Pierce and W. E. Spicer, Electronic structure of amorphous Si from photoemission and optical studies, PHYS. REV. B 5, 3017-3029 (1972). G. K. M. Thutupalli and S. G. Tomlin, The optical properties of amorphous and crystalline silicon, JOURNAL OF PHYSICS C: SOLID STATE PHYSICS, Volume 10, Number 3 .
a-Si:H (refers in this case specifically to hydrogenated a-Si at 9% atomic weight of hydrogen)—D. R. Mckenzie et. al., Optical properties of a-Si and a-Si:H prepared by DC magnetron techniques, PHYS. C. SOLID STATE PHYS. 16, 4933-4944 (1983), with the data scaled to be consistent with that of a-Si from Handbook of Optical Constants of Solids, Edward D. Palik, ed. Academic Press, Boston, 1985.
FeS₂—B. G. Ganga, C. Ganeshraj, A. Gopal Krishna and P. N. Santhosh, Electronic and optical properties of FeSe2 polymorphs: solar cell absorber, available at, https://arxiv.org/ftp/arxiv/papers/1303/1303.1381.pdf.
Al—A. D. Rakić, Algorithm for the determination of intrinsic optical constants of metal films: application to aluminum, APPL. OPT. 34, 4755-4767 (1995).

For comparison to Examples 3-37, the calculated average visible specular reflectance % R for aluminum flake pigments in Examples 1 and 2 is 91.4%. Additionally, average specular transmittance % T for Examples 1 and 2 is 0.0%. All of the two-layer stacks in Examples 3-12 show average visible specular reflectance values well below that of Examples 1 and 2. The stacks described by Examples 18, 19, 29, and 30 have good average visible specular reflectance with % R>80% and have wavelength bandwidth (Δλ) greater than 300 nm and would therefore be expected to have brightness and metallic luster approaching that of aluminum flakes. The stacks described by Examples 20, 22, 23, 31, and 33 have greater average visible reflectance than aluminum and have wavelength bandwidth (Δλ) greater than 300 nm. Thus, pigment flakes made from the stacks described by Examples 20, 22, 23, 31, and 33 would be expected to provide similar brightness and metallic luster appearance in coatings as aluminum flake pigments. Comparing Example 20 to Example 23 shows that varying the layer thicknesses to all be different (rather than a simple alternating stack of the same thickness for each layer of the same material in the stack) can achieve similar average visible specular reflectance, but also advantageously reduce the chroma (for less color, for example, more neutral silver color). The stacks described by Examples 16, and 27 would provide good average visible specular reflectance (% R>80%). However, Examples 16 and 27 do not have sufficient wavelength bandwidth to cover the full visible range (they have Δλ<300 nm), and thus, these would not be expected to have neutral color. The examples shown in Tables 2-5 also illustrate that a greater difference of the average index of refraction Δn of the materials of the alternating layers provides both higher average visible specular reflectance % R and larger wavelength bandwidth Δλ, as long as the extinction coefficient of the materials making up the layers is not large, such as no larger about (Δn)²/15. Additionally, the examples shown in Tables 2-5 illustrate that the average extinction coefficient kₐᵥₑ influences absorptance, reflectance, and potentially color. To quantify an acceptable value of kₐᵥₑ for a given nₐᵥₑ, the quantity Q for the high refractive index material is useful. Q values of at least 0.930 can provide sufficiently high average visible specular reflectance (% R>80) with a sufficiently large wavelength bandwidth (Δλ>300 nm) to achieve a desirable luster, sparkle, and/or metallic color.

Prophetic Example 38: Theoretical Si/SiO₂ Six-Layer Stack Made into Pigment Flakes

The multilayer stacks of Example 18, 20, and 21 can be made by sputter deposition or by electron beam deposition, or by other vapor deposition methods in a vacuum deposition system onto a removable substrate such as a PET (polyethylene terephthalate) film or moving web (e.g., a polypropylene film) or a drum.

Since the stacks of Examples 18, 20, and 21 are non-metallic and made of electrically non-conducting materials (for Si resistivity=2×10⁵ Ωcm and conductivity=5×10⁻⁶ S/cm; and for SiO₂ resistivity=1×10¹⁵ Ωcm and conductivity=1×10⁻¹⁵ S/cm), it is expected that the resulting electrical resistivity of the stack would be of at least 1 Ωcm, such as at least 50 Ωcm. Therefore, it is expected that pigment flakes made from this stack and incorporated into coatings would result in coatings having an OWRTL of no greater than 1.5 dB as measured by the radar transmission system in a radar range of 76 GHz to 81 GHz.

Prior to deposition of the stack, the support could be coated with a release layer or soluble film. After the deposition of the stack, the multilayer stack with the release layer or soluble film could be removed from the substrate with an air knife assembly or simply with a vacuum assembly, or alternatively the release layer would be dissolved by treatment or immersion in solvent to release the multilayer stack from the support. The process of using a release layer or a soluble film to produce PVD aluminum pigments is described in U.S. Pat. No. 6,317,947, Japanese Patent No. JP10152625, U.S. Patent Publication No. 2015/290713, and “PVD Aluminum Pigments: Superior Brilliance for Coatings & Graphic Arts,” Paint & Coatings Industry, Jun. 1, 2000, all of which are hereby incorporated by reference herein.

An example of a release layer is WATCO Clear Gloss Lacquer (Product #63014, available from Rust-Oleum Corp.) with 2 wt % on solution of K-Sperse 131 (available from King Industries, Inc.) which could be applied by spray application using a high volume low pressure (“HVLP”) gravity fed spray gun (Anest Iwata WS400) with a 1.3 mm nozzle and 28 psi (193 kPa) at the gun. The clear gloss lacquer could be applied to the support substrate, the moving web, or the drum in two coats with a flash between coats until the first applied coat was visually dry. This release layer can be dissolved in a solvent such as n-butyl acetate or acetone.

Another example of a release layer is a 30% solution of PARALOID B-66 (from DOW Chemical Company) in acetone, which could be applied by spray application using a high volume low pressure (“HVLP”) gravity fed spray gun (Anest Iwata WS400) with a 1.3 mm nozzle and 28 psi at the gun. The solution could thus be applied to the support substrate, the moving web, or the drum in two coats with a flash between coats until the first applied coat was visually dry. The solution could alternatively be applied by slot die coating to a support substrate, the moving web, or the drum. This release layer can be dissolved in a solvent such as n-butyl acetate or acetone.

After removing the multilayer stack from the support, it could be milled and sized using standard pigment flake milling and sizing methods to result in flake pigments having an average particle size in a range of 2 to 100 microns, such as 5 to 60 microns, or 10 to 40 microns, such as 15 microns, 20 microns, 25 microns, or 30 microns. The thickness of the flakes is the sum of the thickness of all the SiO₂ and Si layers, namely 3×(104.3 nm+25.4 nm), which is about 389 nm.

A milling and sizing process could be performed by collecting all the stack material that has been removed from the support substrate into a container with solvent. The container could be vigorously shaken to dissolve any residual release layer and break apart the stack into pigment flakes. The shaking could continue until the average size of the pigment flakes is satisfactory, such as, for example, when the pigment has an average particle size in a range of 2 microns to 100 microns. The flakes could be cleaned and filtered by settling and rinsing with clean solvent. Additionally, the flakes could be sized using a series of sieves to remove flakes and particles that are outside the desired average particle size range.

Prophetic Example 39: Coating Containing Pigment Flake from Example 38

The pigment flakes of Example 38 could be stirred into DBC500, an automotive refinish solvent-borne polyacrylate based coating from PPG Industries, Inc., at a pigment volume concentration of 11.1% of the non-volatile components of the coating. A reducer, DT870, solvent blend available from PPG Industries, Inc., could be added at a 1:1 volume ratio to the amount of DBC500 and stirred by hand prior to application. The coating could then be applied using the Panel Coating Method.

The following properties of the applied coatings would be anticipated as shown in Table 7:

TABLE 7
Expected Properties of coated Panel

| Average OWRTL (dB) | L₁₅ | Flop Index |
|---|---|---|
| ≤1.5 dB | ≥120 | ≥10 |

### Example 40: Comparative Coating Containing Aluminum Flake Pigment

9.31 g of ALPASTE TCR 3040 aluminum paste (available from Toyo Aluminum K.K.) was stirred into 121.71 g of DBC500, an automotive refinish solvent-borne polyacrylate based coating from PPG Industries, Inc. A reducer, DT870, solvent blend available from PPG Industries, Inc., was added at a 1:1 volume ratio to the amount of DBC500 and stirred by hand prior to application. The resultant coating had 11.1% pigment volume concentration of aluminum flake based on the volume of the non-volatile components of the coating. The coating was then applied according to the Panel Coating Method.

The following properties of the applied coatings were observed as shown in Table 8 below:

TABLE 8
Properties of Comparative Coated Panel

| SU4902/SUA4903 | Sealer DFT | Example | Clearcoat | Average | | |
|---|---|---|---|---|---|---|
| DFT (mil | (mil | 40 DFT (mil | DFT (mil | OWRTL | | Flop |
| [micron]) | [micron]) | [micron]) | [micron]) | (dB) | L₁₅ | Index |
| 0.05 [1.3] | 0.85 [21.6] | 0.75 [19.1] | 2.50 [63.5] | 1.78dB | 147.95 | 18.55 |

As can be seen from the above examples the pigment according to the present disclosure and coatings comprising the pigments according to the present disclosure can approximate the appearance of an aluminum pigment while also improving the OWRTL.

Various methods are now illustrated.

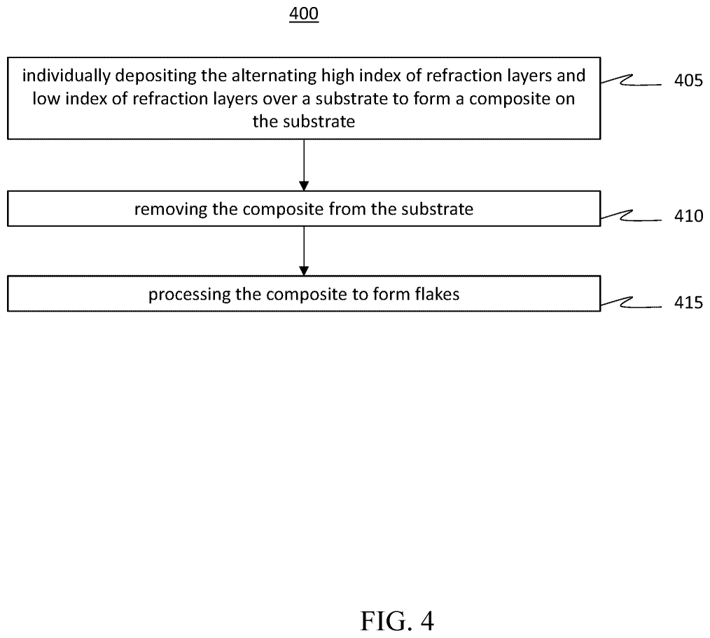

One example method 400 is illustrated in FIG. 4. FIG. 4 illustrates a method 400 of making a pigment. The method comprises individually depositing the alternating high index of refraction layers and low index of refraction layers over a substrate to form a composite on the substrate (405). The method 400 further comprises removing the composite from the substrate (410). The method 400 further comprises processing the composite to form flakes (415). The alternating high index of refraction layers and low index of refraction layers comprise at least four layers comprising alternating low index of refraction layers and high index of refraction layers. A difference in an average index of refraction between adjacent layers, as measured over a wavelength range of 400 nm to 700 nm, is at least 1.5, and the high index of refraction layers have a Q value of at least 0.930, wherein:

$$Q = ( 3 / 2 ) \times ( {n}_{ave} - ( {k}_{ave} / 2 ) ) / ( {n}_{ave} + 2 ) ,$$

Where kₐᵥₑ is an average extinction coefficient of the high index of refraction layers over a wavelength range of 400 nm to 700 nm; and nₐᵥₑ is an average index of refraction of the high index of refraction layers over the wavelength range of 400 nm to 700 nm. The at least four layers has an average visible specular reflectance of at least 80%, and the at least four layers has a bandwidth of at least 300 nm between an upper wavelength and a lower wavelength at which a specular reflectance drops below 50%.

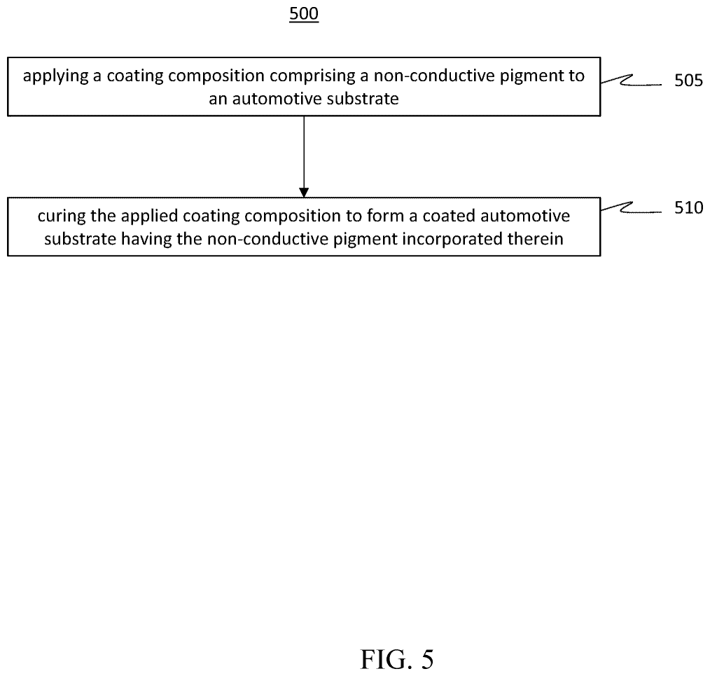

FIG. 5 illustrates a method 500 of improving radio detection and ranging in an electromagnetic radiation frequency range of 76 GHz to 81 GHz, with automotive radar sensors that are mounted behind metallic effect-coated articles. The method 500 comprises applying a coating composition comprising a non-conductive pigment to an automotive substrate (505). The method 500 further comprises curing the applied coating composition to form a coated automotive substrate having the non-conductive pigment incorporated therein (510). The non-conductive pigment includes at least four layers comprising alternating low index of refraction layers and high index of refraction layers. A difference in an average index of refraction between adjacent layers as measured over a wavelength range of 400 nm to 700 nm is at least 1.5. The high index of refraction layers have a Q value of at least 0.930, which is given by:

$$Q = ( 3 / 2 ) \times ( {n}_{ave} - ( {k}_{ave} / 2 ) ) / ( {n}_{ave} + 2 ) ,$$

kₐᵥₑ is an average extinction coefficient of the high index of refraction layers over a wavelength range of 400 nm to 700 nm. nₐᵥₑ is an average index of refraction of the high index of refraction layers over the wavelength range of 400 nm to 700 nm. The non-conductive pigment has an average visible specular reflectance of at least 80%, and the at least four layers has a bandwidth of at least 300 nm, between an upper wavelength and a lower wavelength at which a specular reflectance drops below 50%

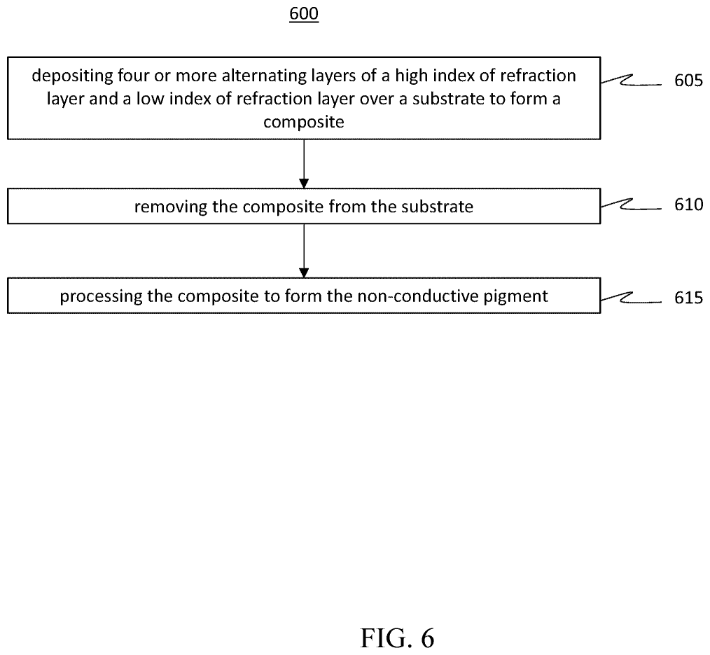

FIG. 6 illustrates a method of making a non-conductive pigment. The method comprises depositing four or more alternating layers of a high index of refraction layer and a low index of refraction layer over a substrate to form a composite (605). The high index of refraction layers comprise silicon and the high index of refraction layers have a Q value of at least 0.930, wherein

$$Q = ( 3 / 2 ) \times ( {n}_{ave} - ( {k}_{ave} / 2 ) ) / ( {n}_{ave} + 2 ) ,$$

kₐᵥₑ is an average extinction coefficient of the high index of refraction layers over a wavelength range of 400 nm to 700 nm. nₐᵥₑ is an average index of refraction of the high index of refraction layers over the wavelength range of 400 nm to 700 nm. The method 600 further comprises removing the composite from the substrate (610). The method 600 further comprises processing the composite to form the non-conductive pigment (615).

The method 600 may be practiced where the depositing of the high index of refraction layers further includes that the high index of refraction layers have the Q value of at least 0.930.

The method 600 may further comprise annealing the composite to increase the Q value of the high index of refraction layers.

The method 600 may be practiced where depositing the high index of refraction layers further comprises that the silicon is deposited in the presence of hydrogen to form hydrogenated silicon.

The method 600 may be practiced where prior to the annealing, the silicon comprises amorphous silicon and after the annealing, the silicon comprises crystalline silicon or polycrystalline silicon.

Notwithstanding that the numerical ranges and parameters setting forth the broad scope of the disclosure are approximations, numerical values set forth in the specific examples are reported as precisely as possible. Any numerical value, however, inherently contains certain errors necessarily resulting from the standard variation found in their respective testing measurements.

Whereas particular examples have been described above for purposes of illustration, it will be evident to those skilled in the art that numerous variations of the details of the present disclosure may be made without departing from the disclosure as defined in the appended claims.

The term “average” as used herein means a “mean” of any variable, x, such as wavelength, diameter, lateral size, thickness, and so forth, is calculated by the equation: average=(1/N)Σxᵢ, where N values of the variable x are being averaged, such that i=1 to N, and Σxᵢ=x₁+x₂+ . . . +x_{N}, as discussed in Data Reduction and Error Analysis for the Physical Sciences, 2^{nd} edition, 1992, pages, 8-9, by Philip R. Bevington and D. Keith Robinson, ISBN 0-07-911243-9.

Various features and characteristics are described in this specification to provide an understanding of the composition, structure, production, function, and/or operation of the present disclosure, which includes the disclosed compositions, coatings, and methods. It is understood that the various features and characteristics of the present disclosure described in this specification can be combined in any suitable manner, regardless of whether such features and characteristics are expressly described in combination in this specification. The Inventors and the Applicant expressly intend such combinations of features and characteristics to be included within the scope of the present disclosure described in this specification. As such, the claims can be amended to recite, in any combination, any features and characteristics expressly or inherently described in, or otherwise expressly or inherently supported by, this specification. Furthermore, the Applicant reserves the right to amend the claims to affirmatively disclaim features and characteristics that may be present in the prior art, even if those features and characteristics are not expressly described in this specification. Therefore, any such amendments will not add new matter to the specification or claims and will comply with the written description, sufficiency of description, and added matter requirements.

Any patent, publication, or other document identified in this specification is incorporated by reference into this specification in its entirety unless otherwise indicated but only to the extent that the incorporated material does not conflict with existing descriptions, definitions, statements, illustrations, or other disclosure material expressly set forth in this specification. As such, and to the extent necessary, the express disclosure as set forth in this specification supersedes any conflicting material incorporated by reference. Any material, or portion thereof, that is incorporated by reference into this specification but that conflicts with existing definitions, statements, or other disclosure material set forth herein, is only incorporated to the extent that no conflict arises between that incorporated material and the existing disclosure material. Applicant reserves the right to amend this specification to expressly recite any subject matter, or portion thereof, incorporated by reference. The amendment of this specification to add such incorporated subject matter will comply with the written description, sufficiency of description, and added matter requirements.

While the present disclosure provides descriptions of various specific aspects for the purpose of illustrating various aspects of the present disclosure and/or its potential applications, it is understood that variations and modifications will occur to those skilled in the art. Accordingly, the present disclosure herein should be understood to be at least as broad as claimed and not as more narrowly defined by particular illustrative aspects provided herein.

According to at least one example of the present disclosures, a non-conductive pigment includes at least four layers comprising alternating low index of refraction layers and high index of refraction layers. A difference in an average index of refraction between adjacent layers as measured over a wavelength range of 400 nm to 700 nm is at least 1.5, at least 2, at least 2.4, at least 2.5, at least 2.7, at least 3, or at least 4. The high index of refraction layers have a Q value of at least 0.930, such as, at least 0.950 or at least 1.000. The Q value is given by

$$Q = ( 3 / 2 ) \times ( {n}_{ave} - ( {k}_{ave} / 2 ) ) / ( {n}_{ave} + 2 ) ,$$

where kₐᵥₑ is an average extinction coefficient of the at least four layers as measured over a wavelength range of 400 nm to 700 nm, and nₐᵥₑ is an average index of refraction of the at least four layers as measured over the wavelength range of 400 nm to 700 nm. The non-conductive pigment has an average visible specular reflectance of at least 80%, such as, at least 85%, at least 90%, or at least 95%, and the non-conductive pigment exhibits at least 50% of a maximum of the visible specular reflectance across the wavelength range of 400 nm to 700 nm.

Additionally, the non-conductive pigment can further include that the high index of refraction layers, individually, comprise crystalline silicon, polycrystalline silicon, hydrogenated silicon, gallium arsenide, gallium phosphide, iron sulfide, germanium, indium phosphide, or a combination thereof. The low index of refraction layers, individually, comprise silicon oxide, silicon nitride, indium tin oxide, magnesium fluoride, tantalum oxide, zirconium oxide, a polymer, or a combination thereof.

According to another example of the present disclosures, the non-conductive pigment can additionally or alternatively be characterized in that the low index of refraction layers are individually inorganic, organic, or a combination thereof and the high index of refraction layers are inorganic.

According to another example of the present disclosures, the non-conductive pigment can additionally or alternatively be characterized in that the pigment has a resistivity of at least 1 Ωcm, such as at least 50 Ωcm as measured with a four-point probe.

According to another example of the present disclosures, the non-conductive pigment can additionally or alternatively be characterized in that the high index of refraction layers respectively have a thickness in a range of 10 nm to 200 nm, such as, 10 nm to 150 nm, 10 nm to 100 nm, 15 nm to 75 nm, 15 nm to 50 nm, 15 nm to 35 nm, or 20 nm to 35 nm and/or the low index of refraction layers, individually, have a thickness in a range of 10 nm to 300 nm, such as, 30 nm to 200 nm, 50 nm to 100 nm, 60 nm to 90 nm, or 70 nm to 90 nm.

According to another example of the present disclosures, the non-conductive pigment can additionally or alternatively be characterized in that each layer has an average extinction coefficient as measured over the wavelength range of 400 nm to 700 nm of less than 2.0, such as, less than 1.7, less than 1.0, less than 0.6, less than 0.5, less than 0.4, less than 0.3, less than 0.2, or less than 0.1.

According to another example of the present disclosures, the non-conductive pigment can additionally or alternatively be characterized in that at least two of the high index of refraction layers have different average index of refractions, thicknesses, compositions, or a combination thereof.

According to another example of the present disclosures, the non-conductive pigment can additionally or alternatively be characterized in that at least two of the high index of refraction layers have the same average index of refractions, thicknesses, compositions, or a combination thereof.

According to another example of the present disclosures, the non-conductive pigment can additionally or alternatively be characterized in that at least two of the low index of refraction layers have different average index of refractions, thicknesses, compositions, or a combination thereof.

According to another example of the present disclosures, the non-conductive pigment can additionally or alternatively be characterized in that at least two of the low index of refraction layers the same average index of refractions, thicknesses, compositions, or a combination thereof.

According to another example of the present disclosures, the non-conductive pigment can additionally or alternatively be characterized in that the non-conductive pigment includes at least five layers, such as, at least six layers, at least seven layers, or at least eight layers.

According to another example of the present disclosures, the non-conductive pigment can additionally or alternatively be characterized in that the non-conductive pigment is a flake pigment and the pigment has an aspect ratio of at least 5, such as, at least at least 10, at least 50, at least 100, at least 500, or at least 1000. The aspect ratio is an average lateral size of the pigment divided by an average thickness of the pigment.

According to another example of the present disclosures, the non-conductive pigment can additionally or alternatively be characterized in that the pigment has an average thickness in a range of 40 nm to 1 micron, such as, 50 nm to 1 micron, 100 nm to 1 micron, 50 nm to 900 nm, 50 nm to 750 nm, 100 nm to 750 nm, 200 nm to 750 nm, 100 nm to 750 nm, 200 nm to 650 nm, or 300 nm to 600 nm, as measured with a transmission electron microscope and/or an average lateral size in a range of 5 microns to 150 microns, such as, 5 microns to 100 microns, 40 microns to 80 microns, 30 microns to 60 microns, 20 microns to 50 microns, 20 microns to 30 microns, 10 microns to 40 microns, 5 microns to 25 microns, or 15 microns to 30 microns, as measured with an optical microscope.

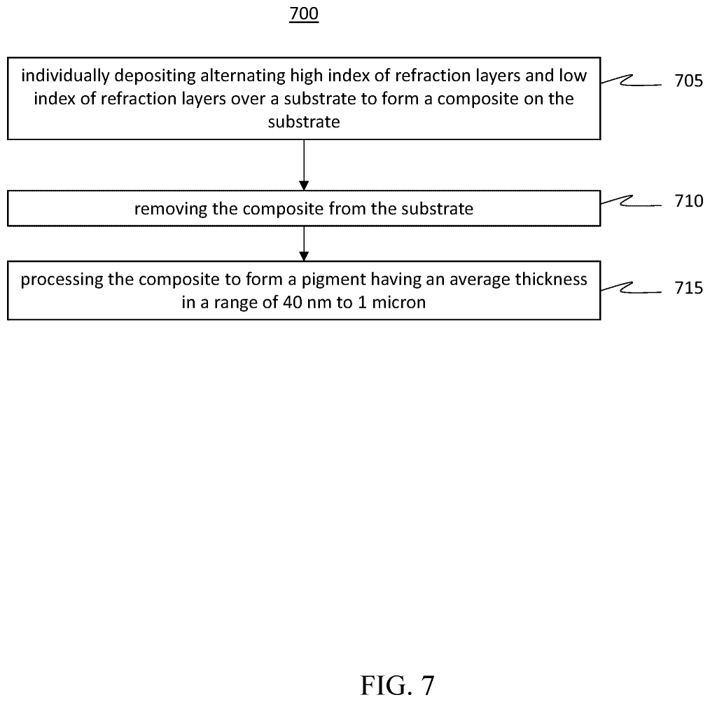

According to another example of the present disclosures, as illustrated in FIG. 7, a method 700 of making the non-conductive pigment of any of the examples above is disclosed. The method 700 includes individually depositing the alternating high index of refraction layers and low index of refraction layers over a substrate to form a composite on the substrate (705). The method further includes removing the composite from the substrate (710). And the method further includes processing the composite to form the pigment having an average thickness in a range of 40 nm to 1 micron (715), such as, 50 nm to 1 micron, 100 nm to 1 micron, 50 nm to 900 nm, 50 nm to 750 nm, 100 nm to 750 nm, 200 nm to 750 nm, 100 nm to 750 nm, 200 nm to 650 nm, or 300 nm to 600 nm, as measured with a transmission electron microscope and/or an average lateral size in a range of 5 microns to 150 microns, such as, 5 microns to 100 microns, 40 microns to 80 microns, 30 microns to 60 microns, 20 microns to 50 microns, 20 microns to 30 microns, 10 microns to 40 microns, 5 microns to 25 microns, or 15 microns to 30 microns, as measured with an optical microscope.

According to another example of the present disclosures, a coating composition is provided. The coating composition includes the non-conductive pigment of any of the examples above and includes a film-forming resin.

According to another example of the present disclosures, the coating composition of the further includes aluminum flakes.

According to another example of the present disclosures, the coating composition can additionally or alternatively be characterized in an additional component comprising an additional pigment, a plasticizer, an abrasion-resistant particle, a film-strengthening particle, a flow control agent, a thixotropic agent, a rheology modifier, cellulose acetate butyrate, a catalyst, an antioxidant, a biocide, a defoamer, a surfactant, a wetting agent, a dispersing aid, an adhesion promoter, a clay, a hindered amine light stabilizer, an ultraviolet light absorber and/or stabilizer, a stabilizing agent, a filler, an organic solvent, water, a reactive diluent, a grind vehicle, or combinations thereof.

According to another example of the present disclosures, a film is provided. The film includes the non-conductive pigment of any of any of the examples above.

According to another example of the present disclosures, a coating layer or a film is provided. The coating layer or the film includes the non-conductive pigment of any of the examples above. And, when applied to a substrate, the coating layer or the film has the properties of: (i) an L₁₅ value of at least 70, at least 80, at least 90, at least 100, at least 110, at least 120, at least 130, at least 140, at least 150, or at least 160, as measured using a multi-angle spectrophotometer at the measurement angle of 15° relative to the specular direction, with D65 illumination and 10° observer; (ii) a flop index of at least 10, at least 12, at least 15, at least 17, at least 19, or at least 21 as measured using a multi-angle spectrophotometer, with D65 illumination and 10° observer according to the following equation:

$$Flop Index = 2.69 {( {L}_{15} - {L}_{110} )}^{1.11} / {( {L}_{45} )}^{0.86}$$

wherein: L₁₅ is CIE L* value measured at the aspecular angle of 15°; L₄₅ is CIE L* value measured at the aspecular angle of 45°; and L₁₁₀ is CIE L* value measured at the aspecular angle of 110°; and/or (iii) one-way radar transmission loss of no greater than 1.5 dB, such as, no greater than 1.3 dB, no greater than 1.0 dB, no greater than 0.7 dB, no greater than 0.5 dB, or no greater than 0.3 dB, as measured using a radar transmission system at a wavelength in a range of 76 GHz to 81 GHz.

According to another example of the present disclosures, an article is provided. The article includes a coating layer that has the non-conductive pigment of any of the examples above; and/or a film that has the non-conductive pigment of any of the examples above.

According to another example of the present disclosures, the article is a bumper fascia, a mirror housing, a fender, a hood, a trunk, a door, or a combination thereof.

According to another example of the present disclosures, the article of any of the examples above has one or more properties of: (i) an L₁₅ value of at least 70, at least 80, at least 90, at least 100, at least 110, at least 120, at least 130, at least 140, at least 150, or at least 160, as measured using a multi-angle spectrophotometer at the measurement angle of 15° relative to the specular direction, with D65 illumination and 10° observer; (ii) a flop index of at least 10, at least 12, at least 15, at least 17, at least 19, or at least 21 as measured using a multi-angle spectrophotometer, with D65 illumination and 10° observer according to the following equation:

$$Flop Index = 2.69 {( {L}_{15} - {L}_{110} )}^{1.11} / {( {L}_{45} )}^{0.86}$$

wherein: L₁₅ is CIE L* value measured at the aspecular angle of 15°; L₄₅ is CIE L* value measured at the aspecular angle of 45°; and L₁₁₀ is CIE L* value measured at the aspecular angle of 110°; and/or (iii) one-way radar transmission loss of no greater than 1.5 dB, such as, no greater than 1.3 dB, no greater than 1.0 dB, no greater than 0.7 dB, no greater than 0.5 dB, or no greater than 0.3 dB, as measured using a radar transmission system at a wavelength in a range of 76 GHz to 81 GHz.

According to another example of the present disclosures, a substrate is provided, wherein the substrate is coated or covered at least in part with a coating composition. The coating composition includes the non-conductive pigment of any of the examples above.

According to another example of the present disclosures, the substrate further includes that the coating composition is applied to the substrate to form a coating layer with a dry film thickness in a range of 0.2 microns to 500 microns, 10 microns to 500 microns, 5 microns to 100 microns, 0.25 microns to 130 microns, 2 microns to 50 microns, or 10 microns to 25 microns.

According to another example of the present disclosures, the substrate of any of the examples above is radar transmissive.

According to another example of the present disclosures, the substrate can additionally or alternatively include a pretreatment layer, an adhesion promoter layer, a basecoat layer, a mid-coat layer, a topcoat layer, a primer layer, or combinations thereof.

According to another example of the present disclosures, a method is provided for improving radio detection and ranging in an electromagnetic radiation frequency range of 1 GHz to 300 GHz, such as, 1 GHz to 100 GHz or 76 GHz to 81 GHz, with automotive radar sensors that are mounted behind metallic effect-coated articles. The method includes applying to an automotive substrate a coating composition and/or film having the non-conductive pigment of any one of the examples above; and/or forming the automotive substrate with the non-conductive pigment of any of any of the examples above incorporated therein.

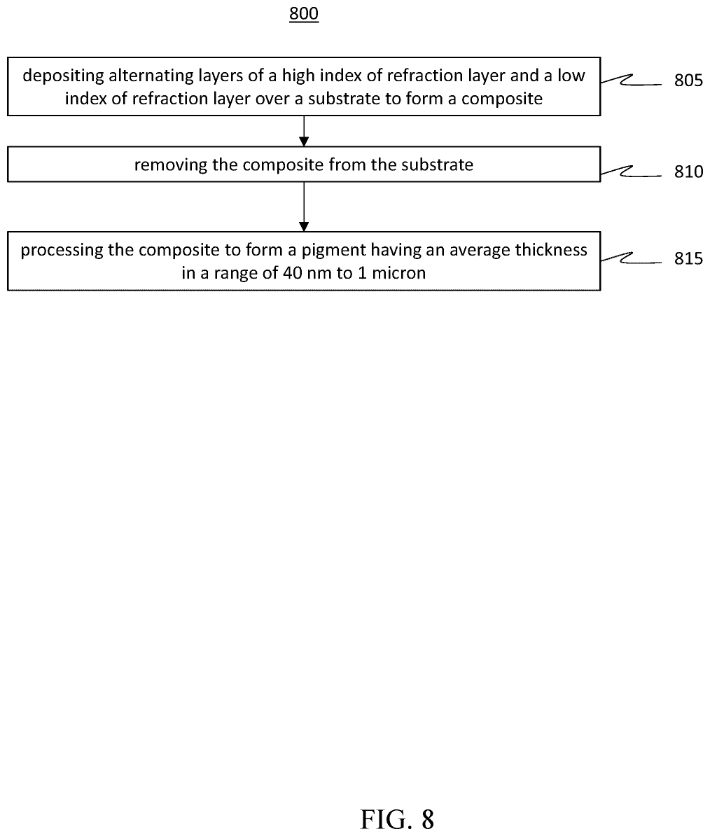

According to another example of the present disclosures as illustrated in FIG. 8, a method 800 is provided for making a non-conductive pigment. The method 800 includes depositing alternating layers of a high index of refraction layer and a low index of refraction layer over a substrate to form a composite (805), wherein the high index of refraction layers include silicon. The method further includes that a Q value of the high index of refraction layers is at least 0.930, such as, at least 0.950 or at least 1.000, wherein

$$Q = ( 3 / 2 ) \times ( {n}_{ave} - ( {k}_{ave} / 2 ) ) / ( {n}_{ave} + 2 ) ,$$

where kₐᵥₑ is an average extinction coefficient of a given layer as measured over a wavelength range of 400 nm to 700 nm; and nₐᵥₑ is an average index of refraction of the given layer as measured over the wavelength range of 400 nm to 700 nm. The method further includes removing the composite from the substrate (810). The method further includes processing the composite to form the pigment having an average thickness in a range of 40 nm to 1 micron (815), such as, 50 nm to 1 micron, 100 nm to 1 micron, 50 nm to 900 nm, 50 nm to 750 nm, 100 nm to 750 nm, 200 nm to 750 nm, 100 nm to 750 nm, 200 nm to 650 nm, or 300 nm to 600 nm. The average thickness of the pigment is as measured with a transmission electron microscope. The processing the composite to form the pigment having an average lateral size in a range of 5 microns to 150 microns, such as, 5 microns to 100 microns, 40 microns to 80 microns, 30 microns to 60 microns, 20 microns to 50 microns, 20 microns to 30 microns, 10 microns to 40 microns, 5 microns to 25 microns, or 15 microns to 30 microns, as measured with an optical microscope.

According to another example of the present disclosures, the method 800 further includes increasing the Q value of the high index of refraction layers by annealing the composite.

According to another example of the present disclosures, the method 800 and/or associated methods further includes that depositing the high index of refraction layers includes that the silicon is deposited in the presence of hydrogen to form hydrogenated silicon.

According to another example of the present disclosures, the method 800 and/or associated methods further includes annealing comprises at least one of heating, ultrasonic annealing

According to another example of the present disclosures, the method 800 and/or associated methods further includes annealing the composite by at least one of heating, ultrasonic annealing, or application of electromagnetic radiation in a range of 100 nm to 2000 nm, such as, application of electromagnetic radiation in a range of 100 nm to 400 nm.

According to another example of the present disclosures, the method 800 and/or associated methods further includes the annealing the composite is performed prior to the removing the composite from the substrate. Alternatively, the annealing the composite is performed during removing the composite from the substrate. Alternatively, the annealing the composite is performed after removing the composite from the substrate.

According to another example of the present disclosures, the method 800 and/or associated methods further includes that, prior to the annealing, the silicon comprises amorphous silicon and after the annealing, the silicon comprises crystalline silicon or polycrystalline silicon.

According to another example of the present disclosures, the method 800 and/or associated methods further includes that the depositing alternating layers occurs at a temperature of no greater than 800 degrees Celsius, such as, no greater than 700 degrees Celsius, no greater than 600 degrees Celsius, no greater than 500 degrees Celsius, or no greater than 400 degrees Celsius.

According to another example of the present disclosures, the method 800 and/or associated methods further includes that the depositing alternating layers includes depositing at least four layers comprising alternating low index of refraction layers and high index of refraction layers.

According to another example of the present disclosures, the method 800 and/or associated methods further includes that the pigment has a visible specular reflectance of at least 80%, such as, at least 85%, at least 90%, or at least 95%, and the pigment exhibits at least 50% of a maximum of the visible specular reflectance across a wavelength bandwidth of at least 300 nm, the visible specular reflectance as measured using an integrating sphere spectrophotometer averaging the reflectance values over a wavelength range of 400 to 700 nm for both a specular component included (SCI) mode and a specular component excluded (SCE) mode, and then subtracting an average reflectance in the SCE mode from an average reflectance in the SCI mode.

According to another example of the present disclosures, a pigment is provided. The pigment is formed according to the method of any one of the methods associated with the method 800.

According to another example of the present disclosures, a method is provided. The method includes using the non-conductive pigment in the examples above in a coating composition, film, or in an automotive substrate.

According to another example of the present disclosures, this method further includes improving radio detection and ranging in an electromagnetic radiation frequency range of 1 GHz to 300 GHz, such as, 1 GHz to 100 GHz or 76 GHz to 81 GHz, with automotive radar sensors that are mounted behind metallic effect-coated articles by using pigment of any one of the examples above in the coating composition, the film, or the automotive substrate.

According to another example of the present disclosures, a non-conductive pigment is provided. The non-conductive pigment includes at least four layers comprising alternating low index of refraction layers and high index of refraction layers, wherein a difference in an average index of refraction between adjacent layers as measured over a wavelength of 400 nm to 700 nm is at least 1.5, at least 2, at least 2.4, at least 2.5, at least 2.7, at least 3, or at least 4, wherein the high index of refraction layers have a Q value of at least 0.930, such as, at least 0.950 or at least 1.000, wherein

$$Q = ( 3 / 2 ) \times ( {n}_{ave} - ( {k}_{ave} / 2 ) ) / ( {n}_{ave} + 2 ) ,$$

where kₐᵥₑ is the average extinction coefficient of the respective layer as measured over a wavelength range of 400 nm to 700 nm; and nₐᵥₑ is the average index of refraction of the respective layer as measured over a wavelength range of 400 nm to 700 nm.

According to another example of the present disclosures, as illustrated in FIG. 9, a method 900 of making a non-conductive pigment is provided. The method 900 includes depositing alternating layers of a high index of refraction layer and a low index of refraction layer over a substrate to form a composite (905). The high index of refraction layers comprise silicon deposit in the presence of hydrogen to form hydrogenated silicon. The high index of refraction layers have a Q value of at least 0.930, such as, at least 0.950 or at least 1.000, wherein

$$Q = ( 3 / 2 ) \times ( {n}_{ave} - ( {k}_{ave} / 2 ) ) / ( {n}_{ave} + 2 ) ,$$

where kₐᵥₑ is the average extinction coefficient of the respective layer as measured over a wavelength range of 400 nm to 700 nm; and nₐᵥₑ is the average index of refraction of the respective layer as measured over a wavelength range of 400 nm to 700 nm. The method 900 further includes removing the composite from the substrate (910). The method 900 further includes processing the composite to form the pigment having an average thickness in a range of 40 nm to 1 micron (915), such as, 50 nm to 1 micron, 100 nm to 1 micron, 50 nm to 900 nm, 50 nm to 750 nm, 100 nm to 750 nm, 200 nm to 750 nm, 100 nm to 750 nm, 200 nm to 650 nm, or 300 nm to 600 nm, as measured with a transmission electron microscope and/or an average lateral size in a range of 5 microns to 150 microns, such as, 5 microns to 100 microns, 40 microns to 80 microns, 30 microns to 60 microns, 20 microns to 50 microns, 20 microns to 30 microns, 10 microns to 40 microns, 5 microns to 25 microns, or 15 microns to 30 microns, as measured with an optical microscope

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

1-21. (canceled)

22. A non-conductive pigment comprising:
a flake comprising at least four layers comprising alternating low index of refraction layers and high index of refraction layers, wherein a difference in an average index of refraction between adjacent layers as measured over a wavelength range of 400 nm to 700 nm is at least 1.5, wherein the high index of refraction layers have a Q value of at least 0.930, which is given by
$$Q = ( 3 / 2 ) \times ( {n}_{ave} - ( {k}_{ave} / 2 ) ) / ( {n}_{ave} + 2 ) ,$$
where
kₐᵥₑ is an average extinction coefficient of the high index of refraction layers over the wavelength range of 400 nm to 700 nm; and
nₐᵥₑ is an average index of refraction of the high index of refraction layers over the wavelength range of 400 nm to 700 nm, and
the non-conductive pigment has an average visible specular reflectance of at least 80%, and the flake has a bandwidth of at least 300 nm between an upper wavelength and a lower wavelength at which a specular reflectance drops below 50%.

23. The non-conductive pigment of claim 22, having a near infrared specular reflectance less than 40% with a near infrared transmittance greater than 60% at at least one of a wavelength of 905 nm or 1550 nm.

24. The non-conductive pigment of claim 22, wherein the high index of refraction layers, individually, comprise crystalline silicon, hydrogenated amorphous silicon, polycrystalline silicon, hydrogenated silicon, gallium arsenide, gallium phosphide, iron sulfide, germanium, indium phosphide, or a combination thereof and the low index of refraction layers, individually, comprise silicon oxide, silicon nitride, indium tin oxide, magnesium fluoride, tantalum oxide, zirconium oxide, a polymer, or a combination thereof.

25. The non-conductive pigment of claim 22, wherein the low index of refraction layers, individually, comprise a polymer.

26. The non-conductive pigment of claim 22, wherein the high index of refraction layers comprise silicon, and the low index of refraction layers comprise silicon oxide.

27. The non-conductive pigment of claim 22, wherein the high index of refraction layers are inorganic.

28. The non-conductive pigment of claim 22, wherein the low index of refraction layers are organic, or a combination of organic and inorganic.

29. The non-conductive pigment of claim 22, wherein the pigment has a resistivity of at least 1 Ωcm.

30. The non-conductive pigment of claim 22, wherein each of the high index of refraction layers have a thickness in a range of 10 nm to 110 nm, and the low index of refraction layers each have a thickness in the range of 80 nm to 180 nm.

31. The non-conductive pigment of claim 22, wherein each layer in that at least four layers has an average extinction coefficient as measured over the wavelength range of 400 nm to 700 nm of less than 2.0.

32. The non-conductive pigment of claim 22, wherein at least two of the high index of refraction layers have different average indexes of refractions, thicknesses, compositions, or a combination thereof.

33. The non-conductive pigment of claim 22, wherein at least two of the low index of refraction layers have different average indexes of refractions, thicknesses, compositions, or a combination thereof.

34. The non-conductive pigment of claim 22, wherein the non-conductive pigment is shaped as a flake having an aspect ratio of at least five, the aspect ratio being an average lateral size of the pigment divided by an average thickness of the pigment.

35. A coating composition comprising:
the non-conductive pigment of claim 22; and
a film-forming resin.

36. A coating layer comprising the non-conductive pigment of claim 22, wherein, when applied to a substrate, the coating layer has:
(i) an L₁₅ value of at least 70, as measured using a multi-angle spectrophotometer at the measurement angle of 15° relative to a specular direction, with D65 illumination and 10° observer;
(ii) a flop index of at least 10, as measured using a multi-angle spectrophotometer, with D65 illumination and 10° observer according to the following equation:
$$Flop Index = 2.69 {( {L}_{15} - {L}_{110} )}^{1.11} / {( {L}_{45} )}^{0.86} ,$$
wherein:
L₁₅ is CIE L* value measured at a aspecular angle of 15°;
L₄₅ is CIE L* value measured at a aspecular angle of 45°; and
L₁₁₀ is CIE L* value measured at a aspecular angle of 110°; and
(iii) one-way radar transmission loss of no greater than 1.5 dB, as measured using a radar transmission system at a wavelength in a range of 76 GHz to 81 GHz.

37. A method for improving radio detection and ranging in an electromagnetic radiation frequency range of 76 GHz to 81 GHz, with automotive radar sensors that are mounted behind metallic effect-coated articles, the method comprising:
applying a coating composition comprising the non-conductive pigment of claim 22 to an automotive substrate; and
curing the applied coating composition to form a coated automotive substrate.

38. A method of making a non-conductive pigment, the method comprising:
depositing four or more alternating layers of a high index of refraction layer and a low index of refraction layer over a substrate to form a composite, wherein the high index of refraction layers comprise silicon and the high index of refraction layers have a Q value of at least 0.890, wherein
$$Q = ( 3 / 2 ) \times ( {n}_{ave} - ( {k}_{ave} / 2 ) ) / ( {n}_{ave} + 2 ) ,$$
where:
kₐᵥₑ is an average extinction coefficient of the high index of refraction layers over a wavelength range of 400 nm to 700 nm; and
nₐᵥₑ is an average index of refraction of the high index of refraction layers over the wavelength range of 400 nm to 700 nm.

39. The method of claim 38, wherein the depositing of the high index of refraction layers further includes that the high index of refraction layers have a Q value of at least 0.930.

40. The method of claim 38, further comprising annealing the composite to increase the Q value of the high index of refraction layers.

41. The method of claim 38, wherein depositing the high index of refraction layers further comprises that the silicon is deposited in the presence of hydrogen to form hydrogenated silicon.

42. The method of claim 40, wherein:
prior to the annealing, the silicon comprises amorphous silicon; and
after the annealing, the silicon comprises crystalline silicon or polycrystalline silicon.
